(19) United States
(12) Patent Application Publication
(10) Pub. No.: US 2016/0185498 A1
(43) Pub. Date: Jun. 30, 2016

(54) Halogen-Free Barrier Constructions and Related Methods

(71) Applicant: Avery Dennison Corporation, Glendale, CA (US)

(72) Inventor: Kevin O. HENDERSON, Willoughby Hills, OH (US)

(21) Appl. No.: 14/970,805

(22) Filed: Dec. 16, 2015

Related U.S. Application Data
(60) Provisional application No. 62/097,961, filed on Dec. 30, 2014.

(51) Int. Cl. B65D 65/38; B32B 37/12; B32B 7/12; B32B 27/30; B32B 7/02; B32B 1/02

(52) U.S. Cl. CPC B65D 65/38; B32B 7/02; B32B 1/02; B32B 7/12; B32B 27/306; B32B 37/12; B32B 2307/7244; B32B 2307/7246; B32B 2439/70

(57) ABSTRACT

A halogen-free multi-layer construction configured to reduce the amount of air in an interior of a sealed container. The multi-layer construction includes an adhesive layer in intimate contact with a barrier layer, and in relation to the barrier layer, the adhesive layer is positioned closer towards the interior of the container. The barrier layer includes a highly amorphous vinyl alcohol polymer. The intimate contact between the adhesive layer and the highly amorphous vinyl alcohol polymer in the barrier layer allows the multi-layer construction to reduce the amount of air in the interior of the container. The multi-layer construction includes water-impermeable interior and exterior layers for preventing liquid water and water vapor from negatively affecting the functioning of the barrier layer.

### CROSS-REFERENCE TO RELATED APPLICATION

The present application claims the benefit of U.S. Provisional Application No. 62/097,961 filed Dec. 30, 2014, which is incorporated herein by reference in its entirety.

### FIELD

The present subject matter relates to halogen-free barrier constructions and related methods suitable for reducing an amount of gas present in a sealed container.

### BACKGROUND

There are many materials in liquid and slurry form now being packaged in containers. Many of these materials are subject to degradation upon exposure to one or more components of air (e.g. nitrogen gas, oxygen gas, hydrogen gas). Some of these materials are sensitive to oxygen (e.g. products for human sustenance such as wine, tomato sauce, etc.) such that the materials oxidize upon exposure to oxygen gas. Once oxidation begins, these beverage and food products may lose their palatability for human consumption, which can affect the shelf-life of the product. Such materials or products that are sensitive to one or more components of air will be referred to herein as “air-sensitive,” “oxygen-sensitive,” “degradable,” “material,” or “product.”

In order to reduce exposure of the material to air, and particularly to oxygen gas, certain air-sensitive material is often packaged in sealed air-tight containers in order to prevent excessive exposure to air, which may cause the material to become unsuitable for its intended purpose. However, when the material is filled into a container and sealed, a certain amount of air may be introduced into the container. The presence of air in a sealed container may result from gas being trapped in the container as the material is sealed into the container, from gas passing through the walls of the container, or from gas passing through the seals of the container. The amount of air in the container is referred to herein as “headspace gas” (HSG) and may include head space oxygen (HSO).

In order to address these concerns and to reduce the likelihood of degradation of the material several techniques have been used to limit or reduce the amount of HSG in the containers. These techniques have included various processes including making adequate seals for the containers so that gas cannot enter the container through the seals; using containers with increased gas barrier properties so that gas cannot enter the container through the walls of the container; drawing a vacuum in the container during the sealing process, or placing the containers in an inert atmosphere during the sealing process in order to reduce the amount of HSG in the container.

In circumstances where containers having increased gas barrier properties have been used, the containers typically have been made from halogen-containing material. An example of a material used in such applications is polyvinylidene chloride (PVDC). Although use of that material is satisfactory in many regards, films containing halogens such as chloride and bromide are difficult and costly to recycle. In fact, with increasing environmental awareness, many regulations prohibit the disposal of halogens; thereby further increasing the inconvenience and/or cost of handling used barrier products containing halogens. Prior artisans have therefore investigated the use of other agents or materials in place of halogens, such as ethylene vinyl alcohol (EVOH).

In circumstances where a vacuum or an inert atmosphere has been used, an increase in cost is typically associated with such packaging procedures, and thereby increases the overall cost of the product. Further, drawing a vacuum may be unsuitable for certain delicate material that could be damaged as a result of drawing a vacuum in the container.

However, even when using these materials and packaging techniques, material that is sealed in an air-tight container (even those packaged under vacuum or in an inert atmosphere) may nevertheless be exposed to air as a result of the characteristics of the air-sensitive material, among other reasons, which can still result in degradation of the material. More specifically, efforts to reduce the amount of HSG in a container may not entirely prevent exposure of the air-sensitive material to gas, including oxygen gas. This phenomenon can result from gas being present in the material that is sealed in the container. That is, the air-sensitive material itself may include gas, which may be dissolved, dispersed or otherwise contained therein. For example, gas sealed in a container may include air that is dispersed in tomato sauce during a mixing or cooking process.

This dissolved or dispersed gas (DG) may include dissolved or dispersed oxygen (DO). After packaging procedures in which substantially all of the HSG is eliminated from the interior of the sealed container, and after forming the container from highly gas-impermeable material, DG may nevertheless come out of, or simply separate from the material and may aggregate into a bubble or other form that is separate and distinct from the material. When the DG aggregates together within the sealed container, the DG may increase the amount of HSG. Therefore, conventional packaging materials and techniques may altogether fail to address the problem of DG being present in the material and accumulating in the sealed container. More specifically, drawing a vacuum or packaging a material in an inert atmosphere, or using highly gas impermeable containers, does not reduce the amount of HSG due to the accumulation of DG that is present in a material sealed in a container.

Accordingly, there exists a need for an improved barrier construction for protecting air-sensitive material from degradation upon exposure to one or more components of air and which is capable of reducing an amount of air present in an interior of a container.

### SUMMARY

The difficulties and drawbacks associated with previously known packaging means and sealing strategies are addressed in the present barrier constructions and related combinations and methods.

The present subject matter relates to barrier constructions used to reduce the amount of gas on one side of the construction, such as HSG and DG located in an interior of a sealed container for example.

In one aspect, the present subject matter provides a container comprising a multi-layer barrier construction configured to reduce an amount of gas in an interior region of the container. The multi-layer barrier construction comprises a barrier layer including a highly amorphous vinyl alcohol polymer. The barrier layer defines an inner face that faces the interior region of the container and an oppositely directed outer face. The multi-layer barrier construction includes an adhesive layer disposed directly on the inner face of the barrier layer.

In another aspect, the present subject matter provides a multi-layer barrier construction defining a first side and an oppositely directed second side. The multi-layer barrier construction is configured to reduce an amount of gas on the first side of the multi-layer barrier construction. The multi-layer barrier construction comprises a first moisture-impermeable layer. The multi-layer barrier construction also comprises an adhesive layer disposed on a side of the first layer closest to the second side of the multi-layer barrier construction. The multi-layer barrier construction also includes a highly amorphous vinyl alcohol polymer layer disposed on a side of the adhesive layer closest to the second side of the multi-layer barrier construction and directly abutting the adhesive layer. The multi-layer barrier construction also includes a second moisture-impermeable layer disposed on a side of the highly amorphous vinyl alcohol polymer layer closest to the second side of the multi-layer barrier construction.

In another aspect, the present subject matter provides a combination comprising a container and a material sealed in an interior of the container. The container includes a multi-layer construction defining a first side facing the interior of the container and an oppositely directed second side. The multi-layer construction is configured to reduce an amount of one or more components of air that is present in the interior of the container. The multi-layer construction includes a moisture-impermeable interior layer, an adhesive layer, a highly amorphous vinyl alcohol polymer layer, and a moisture-impermeable exterior layer. The adhesive layer is disposed on a side of the interior layer closest to the second side of the multi-layer construction. The highly amorphous vinyl alcohol polymer layer is disposed on a side of the adhesive layer closest to the second side of the multi-layer construction, and the highly amorphous vinyl alcohol polymer layer directly abuts the adhesive layer. The moisture-impermeable exterior layer is disposed on a side of the highly amorphous vinyl alcohol polymer layer closest to the second side of the multi-layer construction.

In another aspect, the present subject matter provides a method of making a multi-layer construction defining a first side and an oppositely directed second side, wherein the multi-layer construction is configured to reduce an amount of gas on the first side of the construction. The method comprises providing a moisture-impermeable first layer having a first face and an oppositely directed second face, the first face defining the first side of the construction. The method also comprises disposing an adhesive second layer on a side of the moisture-impermeable first layer that is nearest the second side of the multi-layer construction. The method also includes depositing a highly amorphous vinyl alcohol polymer third layer on a side of the adhesive second layer that is opposite from the moisture-impermeable first layer such that the adhesive second layer and the highly amorphous vinyl alcohol polymer third layer directly abut.

In still another aspect, the present subject matter provides a method of reducing an amount of gas in a container, wherein the container includes a wall that separates an interior of the container from an exterior of the container. The method comprises providing a multi-layer construction that includes a highly amorphous vinyl alcohol polymer layer and an adhesive layer. The adhesive layer directly abuts the highly amorphous vinyl alcohol polymer layer. The method further includes arranging the multi-layer construction such that the construction defines at least a portion of the wall separating the interior from the exterior and wherein the adhesive layer is disposed on a side of the highly amorphous vinyl alcohol polymer layer closest to the interior of the container. In practicing the method, the highly amorphous vinyl alcohol polymer layer is subject to conditions less than about 65% relative humidity.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

These, as well as other features, aspects, and advantages of the present subject matter, will be more completely understood and appreciated by referring to the following more detailed description of the exemplary embodiments of the present subject matter in conjunction with the accompanying drawings.

FIG. 1 is a schematic, perspective view of a multi-layer barrier construction in accordance with the present subject matter.

FIG. 2 is a schematic, cross-sectional view of a container in accordance with the present subject matter.

FIG. 3 is a schematic, cross-sectional view of another container in accordance with the present subject matter.

FIG. 4 is a schematic, perspective view of a combination in accordance with the present subject matter.

FIG. 5 is a graph showing barrier performance of a highly amorphous vinyl alcohol polymer film structure compared with another polymer film structure at varying humidity levels.

FIG. 6 is a graph showing water solubility of a highly amorphous vinyl alcohol polymer compared with polyvinyl alcohol.

### DETAILED DESCRIPTION OF THE EMBODIMENTS

Barrier constructions in accordance with the present subject matter are configured to decrease the amount of HSG and DG on one side of the barrier construction. In one embodiment, when a barrier construction in accordance with the present subject matter is incorporated as part of a container housing an air-sensitive material, the barrier construction is configured to reduce the amount of gas in the interior of the sealed container. Accordingly, the barrier construction may thereby prevent degradation of air-sensitive material (e.g. oxygen-sensitive material) that is sealed in such containers, among other benefits, by reducing the amount of HSG and decreasing the amount of DG that may separate out from the material itself.

The subject matter described herein provides a multi-layer barrier construction comprising a combination of a barrier coating or layer comprising a barrier material, buttressed by an adhesive layer on one side of the barrier layer, and protected from liquid water and water vapor (hereinafter, “water”) by one or more layers that are impermeable to liquid water and have a low water vapor transmission rate (WVTR). The barrier constructions of the present subject matter provide the novel characteristic of reducing an amount of air (including oxygen gas) present on one side of the barrier construction, wherein the air on one side of the barrier construction can be air in an interior of a container.

The barrier construction can be incorporated into any type of container, and is especially useful in containers for materials that are subject to degradation upon being exposed to various components of air, such as for example oxygen gas. Designation of material as being air-sensitive or otherwise, should not be construed to limit the scope of the present subject matter, as it will be appreciated that the barrier construction can be used in packaging for material that is not subject to degradation upon being exposed to various components of air.

In certain embodiments, the barrier construction is configured to be sealed to itself to define the entirety of a sealed container, or can be incorporated as a portion of sealed containers, such as a lid sealed on a tray. In these embodiments, the barrier construction is configured to prevent the material contained therein from being released to the exterior of the container. In these various aspects, the barrier construction is also capable of decreasing an amount of gas, such as oxygen and other gases that may be present in an interior of the sealed container.

The barrier construction can be alternatively used to separate one material from another. For example, the interior of a tube, bottle, or other type of container can be separated into two portions by the barrier construction. A first portion of the container can contain an air-sensitive material. In this aspect, the barrier construction is configured to reduce the amount of air in the first portion of the container that houses the air-sensitive material.

This novel functioning of the barrier construction for reducing the amount of air on one side of the barrier construction, may decrease the need for using an inert atmosphere or for drawing a vacuum when packaging air-sensitive material. Further, an amount of air that may be trapped inside the container—either when the container is sealed (e.g. HSG) or that which is present in the material itself (e.g. DG)—can be reduced.

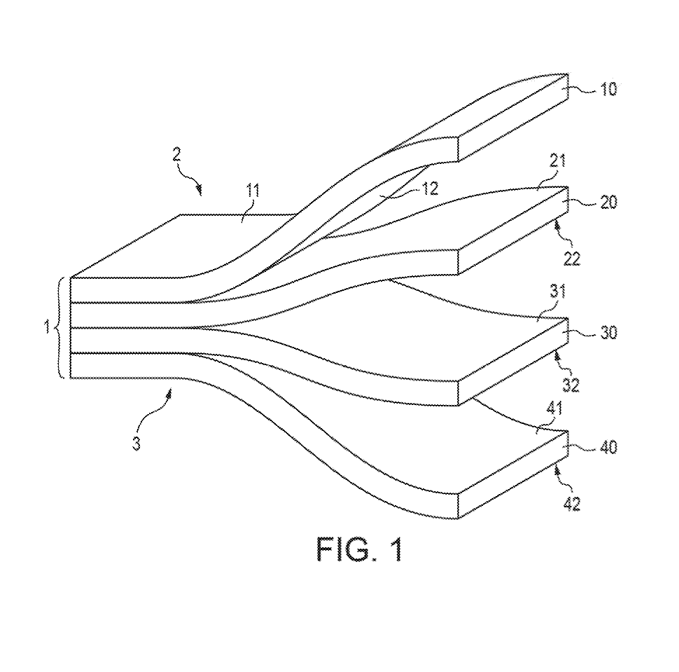

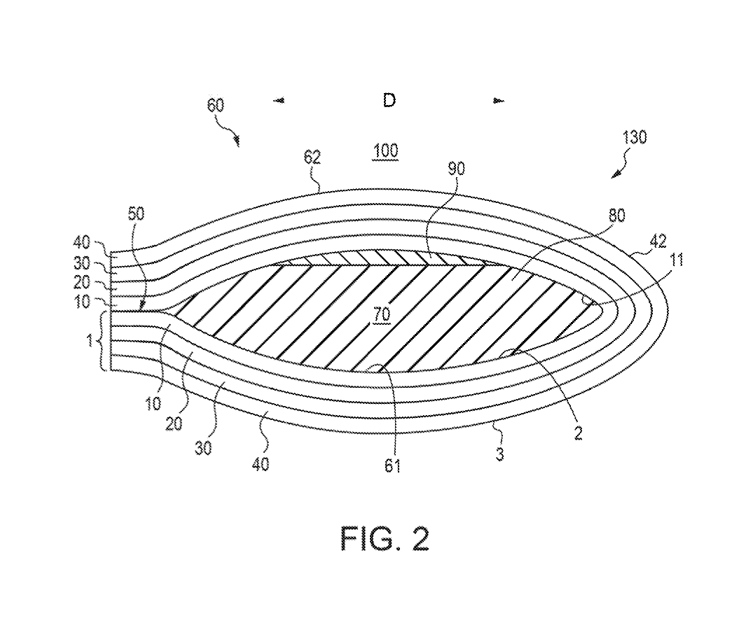

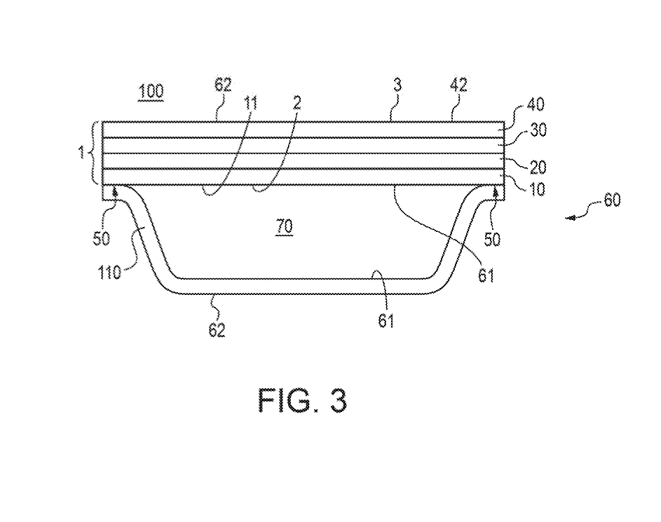

In one embodiment and in reference to FIG. 1, the barrier construction comprises a multi-layer construction 1 defining a first side 2 and an oppositely directed second side 3. The multi-layer construction 1 shown in FIG. 1 includes four layers. However, it will be understood that the multi-layer construction 1 can include more or less, and different layers than that depicted in FIG. 1. From the first side 2 to the second side 3, the multi-layer construction 1 includes a water-impermeable first layer 10, an adhesive second layer 20, a barrier third layer 30, and a water-impermeable fourth layer 40. When the barrier construction is incorporated as part of a container as in FIGS. 2-3, the first side 2 of the multi-layer construction 1 may face an interior 70 of the container and the second side 3 may face the exterior 100 of the container 60, such that the first layer 10 is situated closest to the interior 70 (i.e. inner region) of the container 60 and the fourth layer 40 may be situated furthest from the interior 70 of the container 60. In this respect, the first layer 10 is also referred to herein as the “interior layer” and the fourth layer 40 is also referred to herein as the “exterior layer.”

In accordance with the present subject matter, the multi-layer construction 1 can be used for housing either an air-sensitive material or for housing a non-air-sensitive material.

As shown in FIG. 1, the interior layer 10 includes a first face 11 and an oppositely directed second face 12; the adhesive layer 20 includes a first face 21 and an oppositely directed second face 22; the barrier layer 30 includes a first face 31 and an oppositely directed second face 32; and the exterior layer 40 includes a first face 41 and an oppositely directed second face 42. As shown in this particular embodiment, the second face 12 of the interior layer 10 is mated with (i.e., directly abutting) the first face 21 of the adhesive layer 20; the second face 22 of the adhesive layer 20 is directly abutting the first face 31 of the barrier layer 30; and the second face 32 of the barrier layer 30 is directly abutting the first face 41 of the exterior layer 40.

It will be understood that the multi-layer construction 1 can be differently constructed and can include more or less layers and other layers than that depicted in the figures. For example, in one embodiment the multi-layer construction 1 does not include the fourth water-impermeable layer 40. Further, other various layers can be incorporated between the layers 10, 20, 30, 40 depicted in the figures, for example. It will also be understood that the various layers 10, 20, 30, 40 of the barrier construction 1 are not necessarily smooth, continuous, and of uniform thickness as depicted in the figures, but may be rough or textured, may be discontinuous, such as having voids therein, patterned, intermittent, or layered, and may be of varying thicknesses as desired for certain applications.

The multi-layer constructions 1 shown in FIGS. 2-3 are similar to the multi-layer construction as shown in FIG. 1. Accordingly, the description of the multi-layer construction for FIGS. 2-3 are omitted because it will be understood that they include the features as described for the multi-layer construction in FIG. 1.

In the embodiment shown in FIG. 2, the barrier construction is a multi-layer construction 1 folded upon itself and sealed. The seal 50 is shown to be formed such that the interior layer 10 is sealed to itself to thereby form a container 60 defining an interior 70. However, it will be understood that the seal 50 can be formed between other various layers. As shown in FIG. 2, the interior 70 of the container 60 is filled with an air-sensitive material 80, and air 90. The air 90 included in the interior 70 of the container 60 can include an amount HSG, which may increase over time due to the accumulation of DG that may be present in the air-sensitive material 80. The gas 90 located in the interior 70 of the container 60 is of a certain amount, which can be reduced by incorporating the multi-layer construction 1 as part of the container 60. As shown in FIG. 2, the seal 50 created between the various portions of the interior layer 10 prevents the material 80 from escaping from the interior 70 of the container 60 to the exterior 100 of the container 60. In this embodiment, the container 60 is a flexible wall bag-type container as shown. However, it will be understood that the container 60 can take on any shape or form and is not particularly limited by the present subject matter.

In the embodiment shown in FIG. 2 the multi-layer construction 1 defines a container, such that the water-impermeable first layer 10 defines an inner most layer of the multi-layer construction 1 that is situated closest to the interior 70 of the container 60. Accordingly, the first face 11 of the interior layer 10 defines the first side 2 of the multi-layer construction 1 and also defines the interior surface 61 of the container 60. Similarly, the second face 42 of the exterior layer 40 defines the second side 3 of the multi-layer construction 1 and also defines the exterior surface 62 of the container 60. It will be understood that both of the first side 2 of the multi-layer construction 1 and the interior surface 61 of the container 60 are not necessarily defined by the first face 11 of the interior layer 10, but that one or more of the first side 2 of the multi-layer construction 1 and the interior surface 61 of the container 60 can be defined by other and different layers that may be incorporated into the multi-layer structure 1. Similarly, it will also be understood that both of the second side 3 of the multi-layer construction 1 and the exterior surface 62 of the container 60 are not necessarily defined by the second face 42 of the exterior layer 40, but that one or more of the second side 3 of the multi-layer construction 1 and the exterior surface 62 of the container 60 can be defined by other and different layers that may be incorporated into the multi-layer structure 1.

In another embodiment and in reference to FIG. 3, the barrier construction is a multi-layer construction 1 that comprises a portion of a container 60. Although not depicted, it will be appreciated that the container 60 shown in FIG. 3 can house a material in a similar way to the container 60 depicted in FIG. 2, and may include HSG and/or DG sealed therein.

As shown, the multi-layer construction 1 in FIG. 3 is used as a lid that is sealed to a tray 110 portion of the container 60, wherein a seal 50 is formed between the tray 110 and the multi-layer construction 1. It will be understood that the configuration of the container 60 including the multi-layer construction 1, can include various sizes and shapes for the multi-layer construction 1 and for the tray 110 portion of the container 60. For example, rather than, or in addition to including a tray 110, the container 60 can comprise a bottle, a bag, a box, or the like having the multi-layer construction 1 sealed over an aperture therein.

As will be understood in reference to FIG. 3, air located in the interior 70 of the container 60 may be of a certain amount, which can be reduced by using the multi-layer construction 1 as part of the container 60. As shown in FIG. 3, the multi-layer construction 1 again includes an interior layer 10 defining a first face 11 that defines the first side 2 of the multi-layer construction 1. The first face 11 of the interior layer 10 is in direct communication with the interior 70 of the container 60. The multi-layer construction 1 also includes an adhesive layer 20, a barrier layer 30, and a water-impermeable exterior layer 40 defining a second face 42 that in turn defines the second side 3 of the multi-layer construction 1. As shown, an interior surface 61 of the container 60 is partially defined by both the first side 2 of the multi-layer construction 1 and the first face 11 of the interior layer 10. The exterior surface 62 of the container 60 is partially defined by both the second side 3 of the multi-layer construction 1 and the second face 42 of the exterior layer 40.

As shown in FIG. 3, the multi-layer construction 1 and tray 110 together define container 60 having an interior 70 suitable for holding air-sensitive material 80 or other material. The seal 50 created between the multi-layer construction 1 and the tray 110 portion of the container 60 restricts egress of the material 80 from the interior 70 of the container 60 to the exterior 100 of the container 60.

In accordance with the present subject matter, each embodiment of the multi-layer construction includes intimate contact between the adhesive layer 20 and the barrier layer 30, wherein other layers that may be included in the multi-layer construction 1 are not located between the adhesive layer 20 and the barrier layer 30. In this regard, several embodiments of the present subject matter include the adhesive layer 20 disposed directly on, contacting, and/or directly abutting the first face 31 of the barrier layer 30.

While not being bound to any particular theory, it is believed that the intimate contact between the adhesive layer 20 and the barrier layer 30 promotes the ability of the multi-layer construction 1 to decrease an amount of air 90 located in the interior 70 of a container 60, and/or to decrease an amount of air located at the first side 2 of the multi-layer construction 1. It is believed that the intimate contact between the adhesive layer 20 and the first face 31 of barrier layer 30 causes the barrier layer 30 to function as a one-way molecular sieve, thereby enabling gas to be transported through the multi-layer construction 1 only from an interior 70 to an exterior 100 of the container 60, while at the same time preventing gas from being transported from the exterior 100 to the interior 70 of the container 60.

More specifically, it is believed that the barrier layer 30 becomes selectively permeable in only one direction (i.e. from the first face 31 to the second face 32) while acting as a barrier in the other direction (i.e. from the second face 32 to the first face 31). Gas can then be transmitted through the barrier layer 30 from the first face 31 (i.e. “inner face”), which contacts the adhesive layer 20, to the second face 32 (i.e. “outer face”). The intimate contact between the adhesive layer 20 and the inner face 31 of the barrier layer 30 is believed to at least partially produce this functioning.

Without the intimate contact between the adhesive layer 20 and the barrier layer 30, it is believed that the barrier layer 30 would not act as a one-way sieve to allow gas to be transported through the barrier layer, but would act as it normally does; that is as a two-way gas barrier that restricts the transport of gas through the barrier layer 30 in both directions. More specifically, if the adhesive layer 20 were not in intimate contact with the barrier layer 30, it is believed that an amount of gas 90 trapped in an interior 70 of a sealed container 60 would not be reduced, but would be maintained at the original amount. Further, it is believed that any DG that may be released from a material may therefore increase the amount of HSG located in the interior 70 of the container 60.

These and other aspects of the various layers of the multi-layer construction 1 are described in more detail below.

### Barrier Layer

In accordance with the present subject matter the barrier layer 30 is configured to reduce the amount of gas located at the first side 2 of the multi-layer construction 1.

As shown in the figures, the barrier layer 30 includes a first face 31 (i.e. inner face) that faces the interior 70 of the container 60, and is closer to the first side 2 of the multi-layer construction 1 than the second face 32. This inner face 31 is in intimate contact with the adhesive layer 20. The second face 32 (e.g., outer face) is oppositely directed from the inner face 31 and faces the exterior 100 of the container 60, or is closer to the second side 3 of the multi-layer construction 1 than the inner face 31. In one aspect, the outer face 32 is in intimate contact with the water-impermeable exterior layer 40. However, it will be understood that the outer face 32 of the barrier layer 30 may not be in intimate contact with the exterior layer 40, wherein other and various layers are inserted therebetween.

In one embodiment, barrier layer 30 comprises an amorphous vinyl-alcohol copolymer resin. Amorphous indicates a condition in which polymer molecules are randomly structured with relatively low percentage crystallinity as compared to crystalline or highly crystalline materials. In one embodiment, the barrier layer 30 is a vinyl alcohol polymer having an average level of crystallinity of less than about 35%, less than about 25%, or less than about 20%, or 10% or less, and is therefore considered a highly amorphous vinyl-alcohol copolymer resin (HAVOH).

In one example, the highly amorphous vinyl alcohol polymer can comprise or consist of a vinyl alcohol homopolymer. In another example, the highly amorphous vinyl alcohol polymer can comprise or consist of a vinyl alcohol copolymer. In yet another example, the vinyl alcohol polymer can comprise or consist of an acetoacetic ester group-containing vinyl alcohol copolymer, or a vinyl alcohol copolymer which has been partially acetalized, or a vinyl alcohol copolymer which comprises vinyl alcohol units having a 1, 2 diol structure, or any combination thereof. In one embodiment the highly amorphous vinyl alcohol copolymer can be fully or partially saponified, wherein all or some of the ester groups in the polymer have been substituted with hydroxyl groups. The degree of saponification of the highly amorphous vinyl alcohol copolymer can be from about 50 mol. % to about 98 mol. %.

An example of a suitable highly amorphous polyvinyl alcohol polymer for use in the barrier layer 30 is Nichigo G-Polymer, including grades AZF8035W, OKS-1024, OKS-8041, OKS-8089, OKS-8118, OKS-6026, OKS-1011, OKS-8049, OKS-1028, OKS-1027, OKS-1109, OKS-1081, and OKS-1083 provided by Nippon Gohsei Synthetic Chemical Industry, Osaka Fukoku Seimei Building, 2-4, Komatsubara-cho, Kita-ku, Osaka 530-0018, Japan.

Nichigo G-Polymer is believed to be resin composition, which comprises: (A) a PVA resin having a 1,2-diol structural unit represented by the following general formula (1):

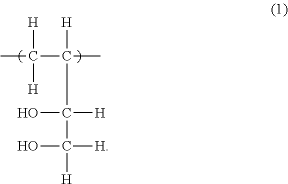

and having a saponification degree of 80 to 97.9 mol %; and (B) an alkylene oxide adduct of a polyvalent alcohol containing 5 to 9 moles of an alkylene oxide per 1 mole of the polyvalent alcohol. Nippon Gohsei also refers to Nichigo G-Polymer by the chemical name, butenediol vinyl alcohol (BVOH).

Performance characteristics of Nichigo G-polymer are as follows.

TABLE 1
Oxygen Barrier Performance

| | | Normalized with |
|---|---|---|
| Samples | cc 20 um/m² day atm | Nichigo G-Polymer |
| Nichigo G-Polymer | 0.0023 | 1 |
| Fully saponified PVOH | 0.0050 | 2 |
| EVOH 29 mol % | 0.07 | 30 |
| EVOH 44 mol % | 1.3 | 600 |
| Nylon 6 | 76 | 35,000 |
| Polypropylene | 3,900 | 1,700,000 |

Table 1 shows oxygen barrier performance in dry conditions at 20° C. of a film formed from Nichigo G-polymer grade OKS-8049, compared to other polymer films.

TABLE 2
Hydrogen Barrier Performance

| Sample | cc 20 um/m2 day atm |
|---|---|
| Nichigo G-Polymer | <3 |
| EVOH 29 mol % | 26 |
| EVOH 44 mol % | 440 |
| Nylon 86 | 900 |
| Nylon 11 | 5,600 |

Table 2 shows hydrogen barrier performance in dry conditions at 41° C. of a film formed from Nichigo G-polymer grade OKS-8049, compared to other polymer films.

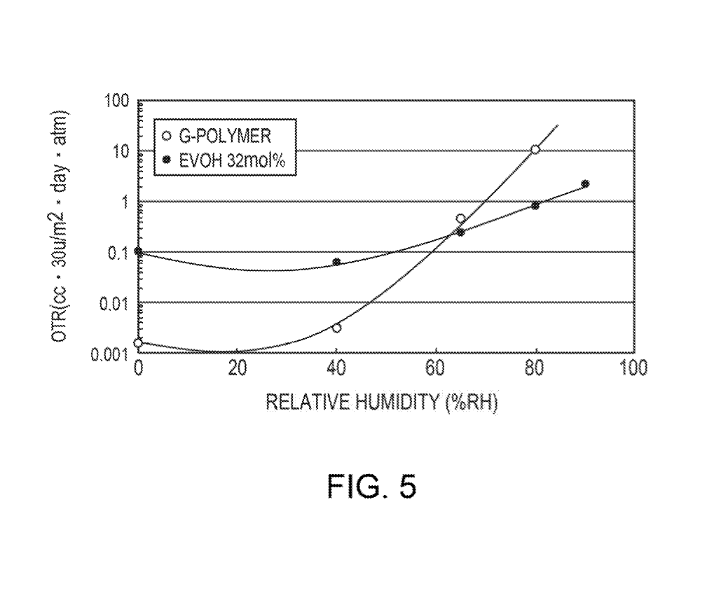

FIG. 5 shows oxygen barrier performance at 23° C. under varying humidity levels of a multi-layer film having one layer of Nichigo G-polymer grade OKS-8049 and a layer of polypropylene, compared to a multi-layer film having one layer of ethylene vinyl alcohol (EVOH) and a layer of polypropylene.

TABLE 3
Vapor Permeability Performance

| | | 40° C. 60% RH | 40° C. 80% RH |
|---|---|---|---|
| Samples | | g 30 um/m² day | g 30 um/m² day |
| Nichigo | Solution cast film | 7.5 | 480 |
| G-Polymer | Extrusion cast film | 6.3 | 470 |
| Fully | Solution cast film | 4.9 | 350 |
| saponified | | | |
| PVOH | | | |
| LDPE | Extrusion cast film | 15 | 20 |

Table 3 shows vapor permeability at 40° C., and at 60% and 80% relative humidity, of a 30 μm thick film formed from Nichigo G-polymer grade OKS-8049, compared to other 30 μm thick polymer films.

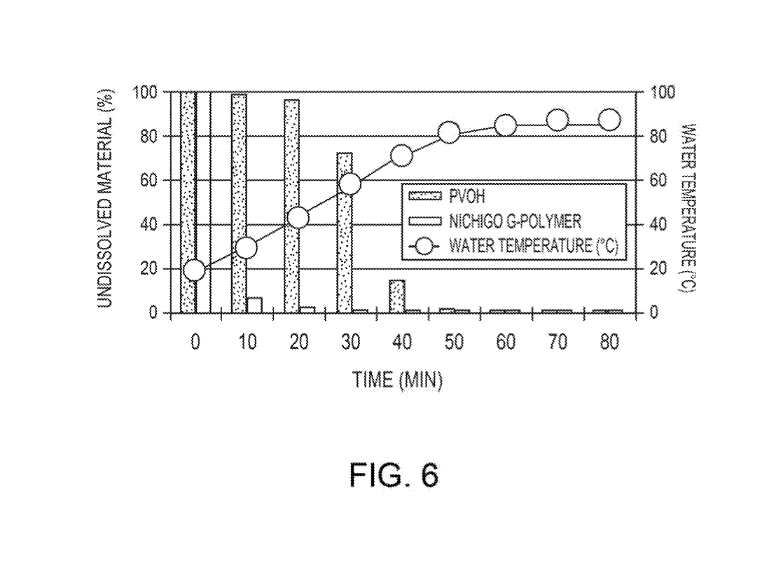

FIG. 6 shows water solubility according to water temperature and time of Nichigo G-polymer at 6% concentration, compared with fully saponified polyvinyl alcohol (PVOH) at 6% concentration.

In one aspect, the barrier layer 30 comprises a dry highly amorphous vinyl alcohol polymer. By “dry” it is meant that water content is substantially removed from the dry highly amorphous vinyl alcohol polymer. Highly amorphous vinyl alcohol polymer is soluble in water but when dry and under conditions of less than 65% relative humidity, the highly amorphous vinyl alcohol polymer normally provides excellent two-way gas barrier properties superior to EVOH or PVOH. Accordingly, the interior layer 10 and the exterior layer 40 are included in the multi-layer construction 1 to maintain the highly amorphous vinyl alcohol polymer in a dry state and under conditions of less than 65% relative humidity so that the gas barrier properties of the barrier layer 30 are not affected by water or moisture from the interior 70 or exterior 100 of the container 60. In one aspect, the barrier layer 30 comprising the highly amorphous vinyl alcohol polymer is in dry form and substantially non-tacky. The highly amorphous vinyl alcohol polymer is a biodegradable thermoplastic that can be extruded, is relatively transparent to visible light with a percent haze of the polymer less than 30%, has a relatively low level of UV light transmittance of less than 15%, and is capable of dissolving in water.

Reducing the amount of air located at the first side 2 of the multi-layer construction 1 is accomplished by applying adhesive directly to the first face 31 of the barrier layer 30. While not being bound to any particular theory, it is believed that the barrier layer 30 comprising the highly amorphous vinyl alcohol polymer is activated by intimate contact between the first face 31 of the barrier layer with the adhesive in the adhesive layer 20, to thereby provide one-way barrier properties for the multi-layer construction 1. By “one-way barrier properties” it is meant that various components of air (such as oxygen gas and hydrogen gas) are substantially prevented from transmitting through the barrier layer 30 in a direction from the second face 32 to the first face 31 of the barrier layer 30, however at the same time, various components of air are capable of being transmitted through the barrier layer 30 in a direction from the first face 31 to the second face 32 of the barrier layer 30.

More specifically, it is believed that air located in the interior 70 of the container 60 is able to exit the container 60 while air located at the exterior 100 is unable to enter the interior 70 of the container 60. Accordingly, it is believed that the barrier layer 30 provides one-way (interior 70 to exterior 100) air permeability for the multi-layer construction 1 and one-way (exterior 100 to interior 70) barrier properties, to thereby reduce an amount of air on one side of the multi-layer construction 1, e.g. in the interior 70 of the container 60.

In one aspect, the barrier layer 30 may be formed by adding together highly amorphous vinyl alcohol polymer and water to form a barrier composition, wherein the highly amorphous vinyl alcohol polymer is dissolved in water. The barrier composition may also include an additive such as glycerin, poly(ethylene oxide) (PEO), or a combination thereof for example, to enhance certain characteristics of the barrier composition or barrier layer. Glycerin can be included to enhance moisture receptivity. PEO can be included to enhance viscosity of the barrier composition for a particular coating application method, such as curtain coating to produce thicker layers greater than 4 g/m² for example. A suitable PEO can comprise Polyox WSR-750 provided by Dow Chemical Company, 2030 Dow Center, Midland, Mich. A barrier composition not including PEO, and therefore having a lower viscosity can be used for rotogravure or direct coating methods. Other additives can be included in the barrier composition as desired for adjusting characteristics of the barrier composition or barrier layer, such as the evaporation rate, viscosity, wettability, rheology, color, and the like. The barrier composition comprising highly amorphous vinyl alcohol polymer, optional additives, and water can be formed into the barrier layer 30 by drying the barrier composition to substantially remove the water content. The amount of highly amorphous vinyl alcohol polymer, optional additives, and water in the barrier composition are not particularly limited by the present subject matter as long as a barrier layer 30 once formed by removing the water content, is of proper thickness and is capable of reducing an amount of gas at the first side 2 of the multi-layer construction 1.

In this regard, the highly amorphous vinyl alcohol polymer can be included from about 5 weight percent (wt %) to about 100 wt % of the total combined weight of highly amorphous vinyl alcohol polymer and optional additives; and the additive(s), such as glycerin and/or PEO) for example, can be included from about 0 wt % to about 25 wt % of the total combined weight of highly amorphous vinyl alcohol polymer and additive(s). The amount of water is not particularly limited and can be added in an amount in order to achieve the desired viscosity of the barrier composition and as appropriate for certain techniques used for forming the barrier layer 30. In another aspect, a highly amorphous vinyl alcohol polymer is extruded by casting or blown into a film to form the barrier layer 30.

The average thickness of the dried barrier layer 30, which is formed by substantially removing the water content from the barrier composition, is not particularly limited by the present subject matter. Because the barrier layer 30 may be protected from water and humid conditions above about 65% relative humidity by one or more of the water-impermeable interior layer 10 and the water-impermeable exterior layer 40, the barrier layer 30 can be a relatively thin layer while still being capable of maintaining adequate barrier properties.

In one embodiment, the barrier layer 30 has an average thickness ranging from about 0.015 μm to about 12 μm or higher, or a coating weight ranging from about 0.1 g/m² to about 85 g/m² or higher. Average barrier layer thicknesses lower than 0.015 μm, or coating weights lower than 0.1 g/m², may not offer sufficient barrier properties for the multi-layered construction 1 such that an amount of air in an interior of a container is not reduced, while thicknesses greater than 12 μm, or coating weights great 85 g/m², may be subject to flex cracking. In one aspect, the barrier layer 30 is present at an average thickness of about 0.15 μm to about 0.30 μm, and particularly at about 0.18 μm; or a coating weight from about 1 g/m² to about 2 g/m², and particularly at about 1.2 g/m². In another aspect, the barrier layer is present at an average thickness of about 0.1 g/m² to about 10 g/m².

When formed into a dry film having sufficient thickness, the highly amorphous vinyl alcohol polymer layer can have an oxygen transmittance rate of less than 0.0023 cc/m²/day at 20° C., 1 atm, and 0% relative humidity.

The barrier layer 30 may comprise other barrier material such as polyvinyl alcohol (PVOH), ethylene vinyl alcohol (EVOH), nylon, polyvinyl acetate (PVA), polyacrylonitrile, polyproplylene, polystryene, polyethylene, and the like. Further, the barrier layer 30 may include additives such as lamellar fillers dispersed therein or may comprise a crystalline or semi-crystalline PVOH that is partially or fully hydrolyzed, or combinations of a crystalline, semi-crystalline, and amorphous PVOH.

### Interior Layer

As will be understood, material 80 packaged in containers comprising the multi-layer construction 1 will often include water. Accordingly, the interior layer 10 is used to contain the material 80 in the interior 70 of the container 60 and is used to prevent transmittance of the water from the interior 70 of the container 60 to the highly amorphous vinyl alcohol barrier layer 30, or to the exterior 100 of the container 60, such that the highly amorphous vinyl alcohol polymer in the barrier layer 30 will remain dry and under conditions of less than 65% relative humidity no matter what type of material is sealed in the container 60.

In several aspects, the multi-layer construction 1 is flexible. In this regard, the interior layer 10 can comprise a flexible material that does not break, crack, or otherwise substantially lose integrity; but remains sufficiently capable of inhibiting liquid water or water vapor that may be present in the interior 70 of the container 60 from reaching the highly amorphous vinyl alcohol polymer barrier layer 30 and the exterior 100 of the container 60.

The interior layer 10 is configured to be substantially water-impermeable in order to maintain the barrier layer 30 in a dry state. Additionally, the interior layer 10 may have a water vapor transmission rate (WVTR) that maintains the barrier layer 30 under conditions of less than 65% relative humidity so that the barrier layer 30 is not undesirably affected by moisture from the interior 70 of the container 60. In one embodiment the interior layer 10 is impermeable to liquid water and has a WVTR of less than about 80 grams per square meter per 24 hours (i.e. g/m²/24 hr) for a layer thickness of 25.4 microns (1 mil) tested at 37.8° C. (100° F.) and at 90% relative humidity; or as converted, less than about 5.2 g/100 in²/24 hr at the same film thickness, temperature, and relative humidity. In another embodiment, the interior layer 10 has a WVTR of less than about 25 g/m²/24 hr (converted 1.6 g/100 in²/24 hr) at the same film thickness, temperature, and relative humidity.

The interior layer 10 is situated closer to the interior 70 of the container 60 than either of the adhesive layer 20 or the barrier layer 30. In one aspect, the interior layer 10 is in intimate contact with the adhesive layer 20 as shown in the figures.

In various embodiments where other layers are included in the multi-layer construction 1, it is important that the interior layer 10 lie on a side of the barrier layer 30 that is closest to the interior 70 of the container 60. In this way, the interior layer 10 can protect the barrier layer 30 from becoming exposed to water or humidity due to the water content of the material sealed in the container 60. Accordingly, this enables the barrier layer 30, comprising highly amorphous vinyl alcohol polymer, to retain its gas barrier functioning independent from the water contents of the container 60. In one aspect, the interior layer 10 is situated closer to the interior 70 than other layers of the multi-layer construction 1. In another aspect, the interior layer 10 defines the first side 2 of the multi-layer construction 1 and the interior surface 61 of the container 60.

If the multi-layer construction 1 did not include the water-impermeable interior layer 10, liquid contents or humidity from the interior 70 of the container 60 may permeate to the barrier layer 30 and as such, could impair the barrier functioning of the highly amorphous vinyl alcohol polymer in the barrier layer 30 and render the barrier layer 60 inadequate for reducing the amount of air located in the interior 70 of the container 60. Exposure to liquid water or water vapor may prevent the highly amorphous vinyl alcohol polymer from adequately preventing gas from being transported from the exterior 100 of the container 60 to the interior 70 of the container 60. If additional HSG were introduced to the interior 70 of the container 60, then air-sensitive material 80 therein may degrade and become unsuitable for its intended purpose.

The interior layer 10 can comprise any material that is capable of preventing liquid water and excessive amounts of water vapor that may originate from the interior 70 of the container 60, from coming into contact with the barrier layer 30. In one aspect, the interior layer 10 comprises a polymeric component that is formed into a continuous film, is water-impermeable, and has a sufficiently low WVTR so as to effectively maintain the barrier properties of the highly amorphous vinyl alcohol polymer in the barrier layer 30.

In another embodiment, the interior layer 10 may also act as a sealant layer so that the multi-layer construction 1 can form the entirety of the container 60, wherein the interior layer 10 can be sealed to itself such as through application of heat or other type of radiation. Alternatively, the interior layer 10 can be sealed to itself or to another layer of the multi-layer construction 1, by using heat, an adhesive, or other sealing mechanism. In either event, the seal 50 formed will restrict the contents of the interior 70 of the package from being released to the exterior 100 of the container 60.

The interior layer 10 may comprise a polymer including one or more of polyethylene, such as low density polyethylene (LDPE), linear low density polyethylene (LLDPE), metallocene linear low density polyethylene (mLLDPE), ultra-low density polyethylene (ULDPE), medium density polyethylene (MDPE), ultra-high weight molecular weight polyethylene (UHWMPE), high density polyethylene (HDPE), polypropylene, polyurethane, polyolefins (linear or branched), halogenated polyolefins, polyamides, polystyrenes, nylon, polyesters including polyethylene terephthalate (PET), polyester copolymers, polyurethanes, polysulfones, styrene-maleic anhydride copolymers, styrene-acrylonitrile copolymers, polyether-amide block copolymers, polyether-ester block copolymers, ionomers based on sodium or zinc salts of ethylene methacrylic acid, polymethyl methacrylates, cellulosics, acrylic polymers and copolymers, polycarbonates, polyacrylonitriles, polybutylene, ionomers, and ethylene-vinyl acetate copolymers. Included in this group are the acrylates such as ethylene methacrylic acid, ethylene methyl acrylate, ethylene acrylic acid and ethylene ethyl acrylate. Also included in this group are polymers and copolymers of olefin monomers having, for example, 2 to about 12 carbon atoms, and in one embodiment, 2 to about 8 carbon atoms. These include the polymer of alpha-olefins having from 2 to about 4 carbon atoms per molecule. These include polyethylene, polypropylene, poly-1-butene, etc. Films prepared from blends of copolymers or blends of copolymers with homopolymers are also useful.

The thickness of the interior layer 10 is not particularly limited so long as the interior layer 10 offers sufficient water impermeability and minimal water vapor transmission rates to protect the barrier layer 30. The average thickness of the interior layer 10 and can range from about 10 microns (μm) to about 1000 μm. In one embodiment, the interior layer 10 has an average thickness of from about 15 to about 100 urn or more, in one embodiment from about 20 to about 80 μm and in another embodiment, from about 40 to about 60 μm, and particularly about 50 μm.

In one embodiment, the interior layer 10 comprises a substantially continuous polymeric film comprising a mixture of metallocene linear low density polyethylene (mLLDPE) and ultra low density polyethylene (ULDPE) at a thickness of about 50 μm. Polyethylene resins, and specifically metallocene polyethylene resins, are flexible to resist stress cracking, yet impact and puncture resistant, and offer heat sealing capabilities so that the interior layer 10 can serve as a sealant layer. In one embodiment, suitable polymeric films are also halogen-free and avoid the use of polyvinylidene chloride (PVDC). In one embodiment, the interior layer 10 is a transparent and conformable. In another embodiment, the interior layer 10 is also elastomeric. The polymeric films used in the interior layer 10 can be produced by blown or cast extrusion.

### Adhesive Layer

In several embodiments, the adhesive layer 20 is used as a tie layer between the barrier layer 30 and the exterior layer 10, and is in intimate contact with the barrier layer 30. As previously described, the adhesive layer 20 may also act as a catalyst in altering the barrier properties of the highly amorphous vinyl alcohol polymer in the barrier layer 30 so that an amount of gas on one side of the multi-layer construction 1 can be reduced.

In one aspect, the adhesive layer 20 is in intimate contact with the first face 31 of the barrier layer 30. That is, the adhesive layer 20 is directly disposed on the barrier layer 30, on a side closest to the interior 70 of the container 60.

As shown in FIGS. 1-3, the adhesive layer 20 lies between the interior layer 10 and the barrier layer 30. In this way, the adhesive layer 20 bonds the interior layer 10 and the barrier layer 30. However, it will be understood that in accordance with the present subject matter, various other layers may lie between the adhesive layer 20 and the interior layer 10.

In one embodiment, the adhesive layer 20 may also act as a cushioning for the relatively thin barrier layer 30. In this way, the average thickness of the adhesive layer 20 can range from about 0.5 μm to about 4.5 μm; or a coating weight of about 4 g/m² to about 30 g/m². Adhesive layer thicknesses and coating weights within this range may provide sufficient cushioning for the barrier layer 30 and allow for flexing of the barrier layer 30 without the barrier layer 30 cracking or otherwise being damaged. Preventing cracking or damaging of the barrier layer 30 may maintain continuity of the barrier layer 30 and may promote more efficient and thorough reduction in the amount of gas 90 in the interior 70 of the container 60.

In other aspects, the adhesive layer 20 is present at an average thickness of about 2.25 μm to about 3 μm, and particularly at about 2.7 μm; or a coating weight from about 15 g/m² to about 20 g/m², and particularly at about 18 g/m². Conventionally thinner adhesive layers having thicknesses of less than about 0.6 μm, or a coating weight of less than about 4 g/m², may not prevent flex cracking of the barrier layer 30 during bending and folding of the multi-layer construction 1.

Further, these conventionally lower coating weights and thinner adhesive layers may not form into a continuous layer, but may include apertures or discontinuities through the layer. Having an adhesive layer that is not continuous may inhibit the adhesive layer 20 in the multi-layer construction 1 from adequately activating the barrier layer 30 to decrease an amount of air located in the interior 70 of the container 60.

Intimate contact between the adhesive layer 20 and the barrier layer 30 provided by the above described coating weight and thicknesses, also promotes various other desirable barrier characteristics for the multi-layer construction 1. More specifically, the barrier layer 30 may contain surface irregularities that can be damaging to the barrier performance of the barrier layer 30, including the one-way barrier properties of the barrier layer 30. While not being bound to any particular theory, it is believed that the adhesive can fill in these irregularities in the first face 31 of the barrier layer 30 and thereby increase the barrier performance of the barrier layer 30.

In another embodiment, two adhesive layers are included in the multi-layer construction 1, wherein the first is disposed directly on the first face 31 of the barrier layer 30 and the second is disposed directly on the second face 32 of the barrier layer 30. In this embodiment, the barrier layer 30 is sandwiched between two adhesive layers. In this construction, the two adhesive layers on either side of the barrier layer 30 may provide increased cushioning for the barrier layer 30 to inhibit flex cracking. In this embodiment, the second adhesive layer that is disposed on the second face 32 of the barrier layer 30 should be tailored so as not to affect the one-way barrier properties of the barrier layer 30 so that an amount of air located in the interior 70 of the container 60 can be reduced while at the same time, air from the exterior 100 of the container 60 will be prevented from being introduced into the interior 70 of the container 60 through the multi-layer construction 1.

The adhesive composition used in the adhesive layer 20 in not particularly limited by the present subject matter, and can include any number or combinations of drying adhesives, contact adhesives, hot-melt adhesives, reactive adhesives, natural or synthetic adhesives, or pressure sensitive adhesives.

In one embodiment, the adhesive used in the adhesive layer 20 compromises a pressure sensitive adhesive (PSA). The PSA can comprise any combination of solvent adhesives, ultraviolet adhesives, 100% solids adhesives, hot melt adhesives, and emulsion adhesives including emulsion acrylic adhesives, or olefin block copolymer adhesives. Suitable pressure sensitive adhesives can be composed of elastomeric polymers with or without tackifiers. A variety of polymers can be used to manufacture suitable pressure sensitive adhesives; for example, acrylic and methacrylic ester homo- or copolymers, butyl rubber based systems, silicones, nitriles, styrene block copolymers, ethylene-vinyl acetate, urethanes, vinyl esters and amides, olefin copolymer materials, natural or synthetic rubbers, and the like. Other pressure sensitive adhesives can be used; such as those comprising polyurethane polymers, for example. Additionally, the emulsion PSAs used in the mufti-layer construction described herein have viscosities (Brookfield) in the range of from about 800 to about 3000 centipoise (cP), preferably in the range of from about 1000 to about 2000 cP. With the addition of a rheology modifier, however, the viscosity of the emulsion PSA may also be raised to greater than 20,000 Cp. The solvent-based PSAs contemplated herein have viscosities in the range of from about 3000 to about 5000 Cp. Solvent PSAs, however, may be formulated with higher percent solids and/or higher molecular weight (Mw) to have viscosities greater than 20,000 Cp. The hot melt PSAs contemplated herein have viscosities in the range of about 5000 to about 15000 Cp at a temperature ranging from about 300° F. (149° C.) to about 350° F. (177° C.), but melt temperature may be varied based on the formulation.

In one embodiment, the adhesive composition is an aqueous mixture of a pressure sensitive adhesive, wherein the aqueous portion of the adhesive composition may be removed by drying to form the adhesive layer 20.

The aqueous polymer compositions generally constitute from about 40% to about 80% by weight of a polymer with the balance being made up of water and minor amounts of volatile organic compounds and unreacted monomer surfactants, tackifiers, etc. Said water may be present in an amount of from about 20% to about 60% by weight of the adhesive composition.

The aqueous mixtures of a pressure sensitive adhesive may comprise an acrylic based polymer matrix comprising particles of the acrylic polymer dispersed in an aqueous medium, or a rubber based polymer matrix adhesive.

The aqueous acrylic based polymers in accordance with the present subject matter may comprise homopolymers and copolymers of various acrylic monomers including alkyl acrylates such as ethyl acrylate, butyl acrylate, propyl acrylate, 2-ethylhexyl acrylate, isooctyl acrylate, isodecyl acrylate, etc.; alkyl methacrylates such as methyl methacrylate, ethyl methacrylate, butyl methacrylate, etc. These acrylate monomers may be copolymerized with vinyl-unsaturated monomers such as vinyl acetate, vinyl propionate; styrenic monomers such as styrene, methyl styrene, etc.; unsaturated carboxylic acids such as acrylic acid, methacrylic acid, itaconic acid, maleic acid, fumaric acid, etc.; acrylamide, vinyl caprolactam, etc. The rubber based pressure sensitive adhesive polymer matrices useful in the process of the present subject matter are normally pressure sensitive adhesive matrices based on styrene and butadiene random polymers and mixtures thereof.

In one exemplary embodiment, the adhesive layer 20 of the present subject matter comprises a pressure sensitive adhesive that forms a permanent bond. In one aspect, the adhesive layer 20 bonds together the interior layer 10 and the barrier layer 30. In another embodiment, the adhesive layer 20 can be used to bond the barrier layer 30 to another different layer.

The copolymers for the adhesive of the instant subject matter can be stabilized against UV and oxidative degradation by using UV stabilizers and antioxidants. Fillers, colorants, tackifiers, plasticizers, oils, and the like, may also be added.

### Exterior Layer

In several aspects, the multi-layer construction 1 includes a water-impermeable exterior layer 40 that may function in many respects similarly to the water-impermeable interior layer 10. As will be understood, containers 60 comprising the multi-layer construction 1 will often be placed in environments subject to water and under conditions of more than 65% relative humidity. Accordingly, the exterior layer 40 is used to prevent transmittance of liquid water or water vapor from the exterior 100 of the container 60 to the highly amorphous vinyl alcohol barrier layer 30. In this way, the highly amorphous vinyl alcohol polymer in the barrier layer 30 can remain dry and can be maintained under conditions of less than 65% relative humidity. Accordingly, the highly amorphous vinyl alcohol polymer may provide superior barrier properties regardless of the environment to which the container 60 is exposed.

In one embodiment, the exterior layer 40 is configured to be substantially water-impermeable in order to maintain the barrier layer 30 in a dry state and isolated from water at the exterior 100 of the container 60. Additionally, the exterior layer 40 may have a water vapor transmission rate that maintains the barrier layer 30 under conditions of less than 65% relative humidity so that the gas barrier properties of the barrier layer 30 are not undesirably affected by moisture from the exterior 100 of the container 60.

In several embodiments, the exterior layer 40 is situated closer to the exterior 100 of the container 60 than the barrier layer 30. It will be understood that the exterior layer 40 is not required to be in intimate contact with the barrier layer 30, but rather, one or more additional and different layers may be disposed therebetween. In one aspect, the exterior layer 40 is in intimate contact with the barrier layer 30 as shown in FIGS. 1-3, wherein the exterior layer 40 is directly disposed on the second face 32 of the barrier layer 30. As such, the water-impermeable fourth exterior layer 40 is disposed closer to the second side 3 of the multi-layer construction 1 than is the barrier layer 30.

In one embodiment the exterior layer 40 is impermeable to liquid water and has a WVTR of less than about 80 grams per square meter per 24 hours (i.e. g/m²/24 hr) for a layer thickness of 25.4 μm (1 mil) tested at 37.8° C. (100° F.) and at 90% relative humidity; or as converted, less than about 5.2 g/100 in²/24 hr at the same film thickness, temperature, and relative humidity. In another embodiment, the exterior layer 40 has a WVTR of less than about 25 g/m²/24 hr (converted 1.6 g/100 in²/24 hr) at the same film thickness, temperature, and relative humidity.

Because the exterior layer 40 is situated closer to the exterior 100 of the container 60 than the barrier layer 30, the exterior layer 40 is able to protect the barrier layer 30 from the liquid and/or humidity that may be present at the exterior 100 of the container 60. As previously described, this protection allows the barrier layer 30, comprising highly amorphous vinyl alcohol polymer, to retain its gas barrier functioning independent from the water in the environment to which the container 60 is exposed. Accordingly, the container 60 may be placed in water-containing environments without substantially affecting the barrier properties of the highly amorphous vinyl alcohol polymer in the barrier layer 30.

If the multi-layer construction 1 did not include the water-impermeable exterior layer 40, the highly amorphous vinyl alcohol polymer in the barrier layer 30 may not adequately reduce the amount of air located in the interior 70 of the container 60. A multi-layer construction 1 not including an exterior layer 40 eventually allows the amount of gas in the interior 70 of the container 60 to increase, rather than decrease. This is because exposure to liquid water or water vapor may impair the gas barrier properties of the highly amorphous vinyl alcohol polymer in the barrier layer 30, and the highly amorphous vinyl alcohol polymer may not adequately prevent gas from being transported from the exterior 100 of the container 60 to the interior 70 of the container 60.

The exterior layer 40 can comprise any material that is capable of preventing liquid water and excessive amounts of water vapor that may originate from the exterior 100 of the container 60, from coming into contact with the barrier layer 30. In one aspect, the exterior layer 40 comprises a polymeric component that is formed into a continuous film, is water-impermeable, and has a sufficiently low WVTR so as to effectively maintain the barrier properties of the highly amorphous vinyl alcohol polymer in the barrier layer 30.

The exterior layer 40 has a thickness that is not particularly limited by the present subject matter so long as the exterior layer 40 offers sufficient water impermeability and minimal water vapor transmission rates to protect the barrier layer 30. In this respect, the exterior layer 40 can comprise a water-impermeable layer having a thickness ranging from about 10 μm to about 1000 μm. In one aspect, the thickness of the exterior layer 40 ranges from about 15 μm to 100 μm, from about 20 to 80 μm, and in one embodiment has a thickness of about 36 μm μm.

The exterior layer 40 may comprise any of the polymers, or combinations thereof, as listed above as being suitable for the interior layer 40. Suitable films used for the exterior layer 40 are halogen-free and avoid the use of polyvinylidene chloride (PVDC). In one embodiment, the exterior layer 40 comprises an uncoated polyethylene terephthalate film that is bi-axially oriented.

### Optional Layers, Additives and Treatments

The multi-layer construction 1 of the present subject matter can include other layers, additives within or separate from the described layers, or treatments and can include printing, printing receptive layers or treatments, hydrophobic layers or treatments, additional laminated film layers, or the like. Examples include priming, printing, hydrophobic treatments, etc. Additives, including air and/or oxygen scavengers, slip and anti-block agents, anti-fogs, antistatics, and processing aids can also be used. The described layers can be coextruded, blended, or laminated with other layers including metal foils, other polymers films, or fillers.

### Combinations

In accordance with the present subject matter, one embodiment depicted in FIG. 2 includes a combination 130 of a material 80 that is packaged inside a sealed container 60 comprising the halogen-free multi-layer construction 1. In one embodiment, the combination 130 comprises an air-sensitive material 80. The container 60 can be entirely defined by the multi-layer construction 1, such as that depicted in FIG. 2; or can be partially defined by the multi-layer construction 1, such as that depicted in FIG. 3, wherein the material 80 is sealed within the interior 70 of the container 60.

The material 80 is not particularly limited by the present subject matter, and can include any material intended for human consumption or sustenance, or any other type of material that may or may not be sensitive to degradation upon exposure to air. For example, the material 80 can include an electronic component that may suffer degradation upon exposure to various components of air.

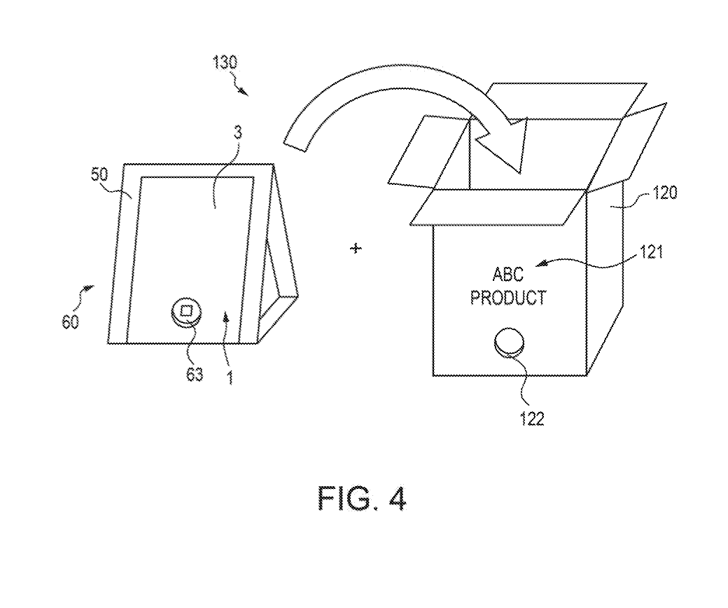

The combination 130 can further include packaging 120 disposed at an exterior 100 of the container 60. Such packaging 120 can be used for advertising or communication purposes, for protection of the container and the material 80, or for other purposes. This aspect is depicted for example in FIG. 4, showing the multi-layer construction bonded to itself with a seal 50 to thereby define a container 60 having a material sealed therein, such that the second side 3 of the multi-layer construction is facing out.

The container 60 is shown in FIG. 4 to include a dispensing means 63 used to access the interior of the container 60 and thereby dispense the material sealed in the container 60 without having to permanently rupture the container 60. Dispensing means 63 can include a spout, a valve, or other structure that can be selectively opened or closed in order to access the material sealed in the interior 70 of the container 60. As shown in FIG. 4, the container 60, and the material sealed therein, are placed (arrow) inside a box-type package 120 having indicia 121 printed thereon and having an opening 122 through which the dispensing means 63 may be accessible from the exterior of the box-type package 120.

One example of this type of combination 130 can be a bag-in-box wine product or other bag-in-box liquid material, wherein the liquid material is sealed inside a flexible bag and placed inside a box for distribution and/or sale. In this aspect, the entire container 60 is defined by the multi-layer construction 1, save for the dispensing means 63. By including the multi-layer construction 1 as part of the container 60, an amount of air that may be sealing in the interior 70 of the container 60 can be reduced in order to maintain the palatability of the air-sensitive material 80 therein.

In accordance with the present subject matter, other various combinations 130 including the multi-layer construction 1 are contemplated. For example, a combination 130 in accordance with the present subject matter may include a material sealed in a container, such as that depicted in FIG. 3 or other type of container including the multi-layer construction 1, with or without packaging 120.

### Methods

In accordance with the present subject matter, various methods of making and using the multi-layer construction 1 are provided.

In one embodiment, a method of making a multi-layer construction 1 defining a first side 2 and an oppositely directed second side 3 is provided, wherein the multi-layer construction 1 is configured to reduce an amount of gas 90 on the first side 2 of the multi-layer construction 1. The method includes providing a water-impermeable first layer 10 and includes disposing an adhesive layer 20 on the side of the water-impermeable first layer 10 that is nearest the second side 3 of the multi-layer construction 1. When incorporated as part of a container 60 as shown in FIGS. 2-3, the first side 2 of the multi-layer construction may face the interior 70 of the container 60 and the first layer 10 may define an interior layer of the multi-layer construction 1.

The method also includes depositing a barrier layer 30 on a side of the adhesive layer 20 that is opposite from the water-impermeable first layer 10, such that the adhesive layer 20 and the barrier layer 30 directly abut and are in intimate contact with each other. In one aspect, the method also includes arranging a water-impermeable fourth layer 40 on a side of the barrier layer 30 that is opposite from the adhesive second layer 20, such that the water-impermeable fourth layer 40 is closer to the second side 3 of the multi-layer construction 1 than the barrier layer 30. The water-impermeable fourth layer 40 may or may not directly abut the barrier layer 30.

In one aspect, wherein a fourth exterior layer 40 is included in the multi-layer construction 1, the method may include adding together a highly amorphous vinyl alcohol polymer, optional additive(s), and water to form a barrier composition, wherein the highly amorphous vinyl alcohol polymer is dissolved in the water. The barrier composition can be applied to the first face 41 of exterior layer 40 and dried thereon. Drying removes the water component in the barrier composition and thereby forms the barrier layer 30 comprising highly amorphous vinyl alcohol polymer in dry form. The method includes applying the barrier composition of highly amorphous vinyl alcohol polymer, optional additive(s), and water in an amount, such that upon drying of the barrier composition, the dry barrier layer 30 has a thickness of about 0.015 μm to about 0.75 μm, and particularly about 0.18 μm; or a dry coating weight from about 0.1 g/m² to about 5 g/m², and particularly about 1.2 g/m². Other methods of forming the barrier layer 30 can be used. In one embodiment, the exterior layer comprises an uncoated PET film or an uncoated bi-axially oriented PET film. In another embodiment, a highly amorphous vinyl alcohol polymer is extruded by casting or blown into a film to form the barrier layer 30.

Once the barrier layer 30 is formed, the method may include depositing the adhesive layer directly on the first face 31 of the barrier layer 30. In one aspect, an adhesive composition is applied directly to the barrier layer 30. The adhesive composition can comprise for example, a solvent adhesive or an emulsion acrylic adhesive that contains a liquid vehicle. The adhesive composition can be dried to thereby remove the liquid vehicle from the adhesive composition and to thereby form the adhesive layer 20 directly on the first face 31 of the barrier layer 30. In this aspect, the interior first layer 10 may then be disposed directly along the adhesive layer 20 in order to make the multi-layer construction 1. In another aspect, the adhesive composition can first be applied to the interior layer 10 and dried thereon in order to form the adhesive layer 20. Thereafter, the adhesive layer 20 on the interior layer 10 can be applied to the first face 31 of the barrier layer 30 on the exterior layer 40 to thereby make the multi-layer construction 1.

When the multi-layer construction 1 is formed, the barrier layer 30 contains a highly amorphous vinyl alcohol polymer that is dry and is in intimate contact with the adhesive layer 20, which is disposed closer to the first side 2 of the multi-layer construction 1 than the barrier layer 30. Intimate contact between the first face 31 of the barrier layer 30 and the adhesive layer 20 thereby promotes the one-way barrier properties of the highly amorphous vinyl alcohol polymer in the barrier layer 20.

When the multi-layer construction 1 is fully assembled, the highly amorphous vinyl alcohol polymer in the barrier layer 30 should be maintained in conditions of less than 65% relative humidity.

In accordance with the present subject matter, a method of reducing an amount of gas 90 in a container 60 is provided. The container 60 can include a wall that defines the container 60 and separates an interior 70 of the container 60 from an exterior 100 of the container 60. The wall can include the multi-layer construction 1 as depicted in FIG. 1. In this regard, the multi-layer construction 1 is arranged such that the wall separating the interior 70 from the exterior 100 of the container 60 is at least partially defined by the multi-layer construction 1. In one aspect, the multi-layer construction 1 defines the entire wall, such as that depicted in FIG. 2 for example. In FIG. 2 the multi-layer construction 1 comprises the entire container 60. In another aspect, the multi-layer construction 1 defines a portion of the wall, such as that depicted in FIG. 3 for example, wherein the multi-layer construction 1 covers an opening in the tray 110. In FIG. 3 the multi-layer construction 1 comprises a portion of the container 60.

The method includes providing a multi-layer construction 1 including a highly amorphous vinyl alcohol polymer barrier layer 30 and an adhesive layer 20. The adhesive layer 20 is disposed on a side of the highly amorphous vinyl alcohol polymer barrier layer 30 that is closest to the interior 70 of the container 60 and directly abuts the highly amorphous vinyl alcohol polymer barrier layer 30. The method includes arranging the multi-layer construction 1, such that the construction 1 defines at least a portion of the wall separating the interior 70 from the exterior 100 of the container 60. The method includes keeping the highly amorphous vinyl alcohol polymer barrier layer 30 dry and under conditions less than about 65% relative humidity. In this regard, and in order to maintain these conditions, the multi-layer construction 1 can optionally include and interior layer 10 and/or an exterior layer 40. The highly amorphous vinyl alcohol polymer of the barrier layer 30 can include Nichigo G-polymer. Other additional operations can be incorporated into the exemplary methods, such as including an air-sensitive material 80 in the interior 70 of the container 60 for example.

### EXAMPLES

The functioning of the multi-layer construction in accordance with the present subject matter is further demonstrated in the following Examples 1-2 and 4 involving multi-layer structures including a highly amorphous vinyl alcohol polymer (HAVOH) as compared with Comparative Example 3. The following Table 4 indicates the construction of various barrier structures.

TABLE 4
Multi-layer Barrier Structures in Examples 1-4

| | | | Comparative | |
|---|---|---|---|---|
| Layer | Example 1 | Example 2 | Example 3 | Example 4 |
| Interior | mLLDPE/LLDPE | mLLDPE/LLDPE | EVA/LDPE/mLLPDE | EVA |
| Layer | (50 μm) | (50 μm) | | (81 μm) |
| Adhesive | Solvent Adhesive | Solvent Adhesive | PP/PE Elastomer | Emulsion Acrylic |
| Layer | (18 g/m²) | (18 g/m²) | | Adhesive |
| | | | | (18 g/m²) |
| Barrier Layer | HAVOH | HAVOH | EVA GMAH/COC | HAVOH |
| | (1.2 g/m²) | (1.2 g/m²) | | (1.2 g/m²) |
| Second | none | none | none | Emulsion Acrylic |
| Adhesive | | | | Adhesive |
| Layer | | | | (18 g/m²) |
| Exterior | PET | none | EVOH/Surlyn | EVA |
| Layer | (36 μm) | | | (81 μm) |

In the above Table 4, Example 1, Example 2, and Example 4 are multi-layer barrier constructions in accordance with the present subject matter including a barrier layer comprising HAVOH in intimate contact with an adhesive layer, while Example 3 is a conventional multi-layer barrier construction not including HAVOH.

The above Examples 1-4 were evaluated by sealing the multi-layer construction to itself in order to form a container similar to that depicted in FIG. 2. In each example, water and an amount of HSG (which included various components of air comprising oxygen gas, nitrogen gas, hydrogen gas, etc.) were sealed in the container using a heat seal.

The following Table 5 indicates performance characteristics in reducing the amount of HSG sealed in each container over time for the above barrier structures of Examples 1-4. The data in Table 5 represents the diameter (D) of the HSG air bubble as represented in FIG. 2 that was sealed in the interior of the container.

TABLE 5
Performance Characteristics of Examples 1-4

| | | | Comparative | |
|---|---|---|---|---|
| Elapsed Time | Example 1 | Example 2 | Example 3 | Example 4 |
| Start | 20 mm | 20 mm | 16 mm (less than | 30 mm |
| | | | about 5% of the | |
| | | | volume of the | |
| | | | interior) | |
| 29 days | 12 mm | 14 mm | | |
| 108 days | | | | 30 mm |
| 118 days | 2 mm | 27 mm | | |
| 128 days | 0 mm | | | |
| 1169 days | | | Increased in size | |
| | | | to about 80-90% | |
| | | | of the volume of | |
| | | | the interior | |

As can be seen, the container formed from the multi-layer construction of Example 1 was able to continually reduce the amount of HSG sealed in the container, as indicated by the diameter (in millimeters) of a bubble, up until at least day 128 until the amount of HSG was decreased such that the bubble had a diameter of approximately zero millimeters. Since air is only about 20% oxygen, there appears to be a removal of all gas types sealed within the container. The container formed from the multi-layer construction of Example 2 was able to initially reduce the amount of HSG sealed in the container, but thereafter the amount of HSG increased between day 29 and day 118. While not being bound to any particular theory, it is believe that the HAVOH barrier layer in Example 2 was exposed to environmental humidity due to there being no exterior layer provided in the multi-layer construction. It is believed that exposure to moisture compromised the barrier properties of the HAVOH barrier layer and thereby allowed the amount of HSG in the container to increase between day 29 and day 118. Although the container formed from the multi-layer construction of Example 4 did not reduce the amount of HSG sealed in the container by day 108, the amount of HSG also did not increase. In contrast to Examples 1-2 and 4, the container formed from the multi-layer construction of Comparative Example 3 increased significantly by day 1169, such that a majority (80%-90%) of the volume of the interior of the container was occupied with gas, rather than with water.

Further analysis was conducted on Examples 1, 2, and 4. The following Table 6 indicates the construction of Examples 1, 2, and 4 and more comprehensive performance characteristics in reducing the amount of HSG sealed in each container over time.

TABLE 6
Multi-Layered Barrier Structures and Performance Characteristics in Examples 1, 2, 4

| Layer | Example 1 | | | Example 2 | | | Example 4 | | |
|---|---|---|---|---|---|---|---|---|---|
| Interior | LLDPE/mPE Film (50 μm) | | | LLDPE/mPE Film (50 μm) | | | EVA Film (18% VA) (81 μm) | | |
| Adhesive 1 | Emulsion Acrylic adhesive | | | Emulsion Acrylic adhesive | | | Hot Melt adhesive (18 gsm) | | |
| | (18 gsm) | | | (18 gsm) | | | | | |
| Barrier | HAVOH (1.2 gsm) | | | HAVOH (1.2 gsm) | | | HAVOH (1.2 gsm) | | |
| Adhesive 2 | None | | | None | | | Hot Melt adhesive (18 gsm) | | |
| Exterior | BOPET (36 μm) | | | None | | | EVA Film (18% VA) (81 μm) | | |
| Reading | Day | Diameter | Area Δ | Day | Diameter | Area Δ | Day | Diameter | Area Δ |
| 1 | 0 | 20.0 mm | 0.0% | 0 | 20.0 mm | 0% | 0 | 25.7 mm | 0.0% |
| 2 | 29 | 12.0 mm | −64.0% | 29 | 14.0 mm | −51% | 68 | 25.7 mm | 0.0% |
| 3 | 88 | 8.0 mm | −84.0% | 88 | 20.0 mm | 0% | 101 | 25.7 mm | 0.0% |
| 4 | 121 | 2.0 mm | −99.0% | 121 | 27.0 mm | 82% | 131 | 27.3 mm | 12.8% |
| 5 | 127 | 0.0 | −100% | 151 | 34.0 mm | 189% | 161 | 25.0 mm | −5.4% |
| 6 | 151 | 0.0 | −100% | 181 | 39.5 mm | 290% | 199 | 23.3 mm | −18% |
| 7 | 181 | 0.0 | −100% | 219 | 48.3 mm | 484% | 220 | 19.0 mm | −45% |
| 8 | 219 | 0.0 | −100% | 240 | 54.0 mm | 629% | 255 | 6.0 mm | −95% |
| 9 | 275 | 0.0 | −100% | 275 | 59.3 mm | 779% | | | |

As can be seen, the container formed from the multi-layer construction of Example 1 was able to continually reduce the amount of HSG sealed in the container up until at least day 127, wherein the amount of HSG was decreased to a diameter of approximately zero and maintained there up to at least day 275. The container formed from the multi-layer construction of Example 2 was able to initially reduce the amount of HSG sealed in the container up to at least day 29, but thereafter the amount of HSG increased between day 29 and day 275. While not being bound to any particular theory, it is believe that the HAVOH barrier layer in Example 2 was exposed to environmental humidity due to there being no exterior layer provided in the multi-layer construction. It is believed that exposure to moisture compromised the barrier properties of the HAVOH barrier layer and thereby allowed the amount of HSG in the container to increase between day 29 and day 275. The container formed from the multi-layer construction of Example 4 did not initially reduce the amount of HSG sealed in the container by day 131, but thereafter did reduce the amount of HSG from day 131 up until at least day 255.

Further analysis was conducted on the following Examples 5-8, involving multi-layer structures including HAVOH. The following Table 7 indicates the construction of various barrier structures and their performance characteristics in retaining the water in the container as measured by weight (wt.) of the water, in reducing the amount of HSG sealed in each container as measured by the diameter (in millimeters) of an air bubble in the container, and in the water vapor transmission rate (WVTR) of the multi-layer structures over time.

TABLE 7
Multi-Layered Barrier Structures and Performance Characteristics in Examples 5-8

| Layer | | Example 5 | | | Example 6 | | | Example 7 | | | Example 8 | | |
|---|---|---|---|---|---|---|---|---|---|---|---|---|---|
| Interior | | EVA Film (18% VA) (81 μm) | | | LLDPE/mPE Film (50 μm) | | | LLDPE/mPE Film (50 μm) | | | EVA Film (18% VA) (81 μm) | | |
| Adhesive 1 | | Hot Melt adhesive (18 gsm) | | | Emulsion Acrylic adhesive | | | Emulsion Acrylic adhesive | | | Hot Melt adhesive (18 gsm) | | |
| | | | | | (18 gsm) | | | (18 gsm) | | | | | |
| Barrier | | HAVOH (1.2 gsm) | | | HAVOH (1.2 gsm) | | | HAVOH (1.2 gsm) | | | HAVOH (1.2 gsm) | | |
| Adhesive 2 | | None | | | None | | | None | | | Hot Melt adhesive (18 gsm) | | |
| Exterior | | BOPET (36 μm) | | | None | | | BOPET (36 μm) | | | EVA Film (18% VA) (81 μm) | | |
| | | | | WVTR | | | WVTR | | | WVTR | | | WVTR |
| | | Wt. | Diameter | g/(m² · | Wt. | Diameter | g/(m² · | Wt | Diameter | g/(m² · | Wt | Diameter | g/(m² · |
| Reading | Day | (g) | (mm) | d · atm) | (g) | (mm) | d · atm) | (g) | (mm) | d · atm) | (g | (mm) | d · atm) |
| 1 | 0 | 423.48 | 45.0 | | 436.03 | 67.5 | | 425.29 | 71.0 | | 418.70 | 61.6 | |
| 2 | 30 | 419.69 | 49.0 | 17.08 | 433.64 | 71.0 | 4.84 | 423.37 | 61.5 | 6.43 | 417.27 | 59.5 | 9.20 |
| 3 | 62 | 415.98 | 48.5 | 16.35 | 431.22 | 78.5 | 4.71 | 421.45 | 65.5 | 6.22 | 415.84 | 61.5 | 8.91 |
| 4 | 94 | 411.66 | 46.5 | 17.00 | 428.12 | 85.0 | 5.11 | 419.02 | 61.0 | 6.70 | 413.98 | 60.0 | 9.69 |
| 5 | 124 | 408.32 | 48.5 | 16.53 | 421.33 | 83.5 | 7.19 | 417.25 | 63.0 | 6.51 | 412.65 | 64.5 | 9.42 |
| 6 | 150 | 405.34 | 52.0 | 16.35 | 423.81 | 94.9 | 4.94 | 415.63 | 62.0 | 6.47 | 411.44 | 68.0 | 9.34 |
| 7 | 228 | 396.97 | 49.0 | 15.72 | 417.74 | 103.6 | 4.87 | 411.02 | 66.5 | 6.29 | 407.95 | 69.5 | 9.10 |

As can be seen, the container formed from the multi-layer construction of Example 5 continually lost water content from its interior, and the amount of HSG sealed in the container generally increased through day 228. The WVTR remained relatively constant around 16 g/(m²·d·atm) up until at least day 228. The container formed from the multi-layer construction of Example 6 continually lost water content from its interior, and the amount of HSG sealed in the container generally increased through day 228. The WVTR remained relatively constant around 5 g/(m²·d·atm) up until at least day 228, which was much lower than Example 5. The container formed from the multi-layer construction of Example 7 continually lost water content from its interior up until at least day 228, but the amount of HSG sealed in the container generally decreased through day 228. The WVTR remained relatively constant around 6.5 g/(m²·d·atm) through day 228. The container formed from the multi-layer construction of Example 8 continually lost water content from its interior up until at least day 228, but the amount of HSG sealed in the container generally decreased through at least day 94. Thereafter, the HSG increased from day 94 through at least day 228. The WVTR remained relatively constant around 9.2 g/(m²·d·atm) through day 228.

Further analysis was conducted on the following Examples 9-12, involving multi-layer structures including HAVOH. The following Table 8 indicates the construction of various barrier structures and their performance characteristics in retaining the water in the container as measured by weight (wt.) of the water, in reducing the amount of HSG sealed in each container as measured by the diameter (in millimeters) of an air bubble in the container, and the ratio of diameter of the air bubble to weight of the water remaining in the container made of the multi-layer structures over time.

TABLE 8
Multi-Layered Barrier Structures and Performance Characteristics in Examples 9-12

| Layer | Example 9 | | | Example 10 | | | Example 11 | | | Example 12 | | |
|---|---|---|---|---|---|---|---|---|---|---|---|---|
| Interior | EVA Film (18% VA) (81 μm) | | | LLDPE/mPE Film (50 μm) | | | LLDPE/mPE Film (50 μm) | | | EVA Film (18% VA) (81 μm) | | |
| Adhesive 1 | Hot Melt adhesive (18 gsm) | | | Solvent adhesive (18 gsm) | | | Solvent adhesive (18 gsm) | | | Hot Melt adhesive (18 gsm) | | |
| Barrier | HAVOH (1.2 gsm) | | | HAVOH (1.2 gsm) | | | HAVOH (1.2 gsm) | | | HAVOH (1.2 gsm) | | |
| Adhesive 2 | None | | | None | | | None | | | Hot Melt adhesive (18 gsm) | | |
| Exterior | BOPET (36 μm) | | | None | | | BOPET (36 μm) | | | EVA Film (18% VA) (81 μm) | | |
| | Wt. | Diameter | | Wt. | Diameter | | Wt. | Diameter | | Wt. | Diameter | |
| Day | (g) | (mm) | Ratio | (g) | (mm) | Ratio | (g) | (mm) | Ratio | (g) | (mm) | Ratio |
| 0 | 1.00 | 1.00 | 1.00 | 1.00 | 1.00 | 1.00 | 1.00 | 1.00 | 1.00 | 1.00 | 1.00 | 1.00 |
| 30 | 0.99 | 1.09 | 1.10 | 0.99 | 1.05 | 1.06 | 1.00 | 0.87 | 0.87 | 1.00 | 0.97 | 0.97 |
| 62 | 0.98 | 1.08 | 1.10 | 0.99 | 1.16 | 1.18 | 0.99 | 0.92 | 0.93 | 0.99 | 1.00 | 1.01 |
| 94 | 0.97 | 1.03 | 1.06 | 0.98 | 1.26 | 1.28 | 0.99 | 0.86 | 0.87 | 0.99 | 0.97 | 0.99 |
| 124 | 0.96 | 1.08 | 1.12 | 0.97 | 1.24 | 1.28 | 0.98 | 0.89 | 0.90 | 0.99 | 1.05 | 1.06 |
| 150 | 0.96 | 1.16 | 1.21 | 0.97 | 1.41 | 1.45 | 0.98 | 0.87 | 0.89 | 0.98 | 1.10 | 1.12 |
| 228 | 0.94 | 1.09 | 1.16 | 0.96 | 1.54 | 1.60 | 0.97 | 0.94 | 0.97 | 0.97 | 1.13 | 1.16 |

As can be seen, the container formed from the multi-layer construction of Example 9 continually lost water content from its interior, and the amount of HSG sealed in the container generally increased through day 228. The ratio of the diameter of the air bubble to the weight of the water was generally about 1.1 through day 228. In Example 9, it is believed that that the EVA interior layer did not protect the HAVOH barrier layer from moisture as well as the interior layer in Example 11, which included LLDPE/mPE. For this reason, it is believed that the HAVOH in Example 9 provided worse barrier properties than Example 11. The container formed from the multi-layer construction of Example 10 continually lost water content from its interior, and the amount of HSG sealed in the container continually increased through day 228. The ratio of the diameter of the air bubble to the weight of the water also continually increase to 1.60 through 228 days, which was significantly higher than Example 9. The container formed from the multi-layer construction of Example 11 continually lost water content from its interior through day 228, but the amount of HSG sealed in the container initially decreased and then remained generally constant around 0.90 mm through 228 days. The ratio of the diameter of the air bubble to the weight of the water remained below 1 through 228 days, which was lower than both of Examples 9 and 10. The container formed from the multi-layer construction of Example 12 continually lost water content from its interior through day 228, but the amount of HSG sealed in the container fluctuated through 228 days. The ratio of the diameter of the air bubble to the weight of the water also fluctuated around 1 through 228 days.

Further analysis was conducted on the following Examples 13-18, involving multi-layer structures including comparative examples 13-15 and 18 not including HAVOH, and Examples 16 and 17 including HAVOH in accordance with the present subject matter. The following Table 9 indicates the construction of various barrier structures. Table 10 indicates the performance characteristics of Examples 13-18 in retaining various liquids (water, wine, vacuum sealed wine) in the container as measured by percent weight loss, in reducing the amount of head space gas (HSG), and in reducing the amount of dissolved or dispersed gas (DG) sealed in each container made of the multi-layer structures over time. For the containers containing wine or vacuum sealed wine, the wine was filled in the containers under atmospheric conditions. For the vacuum-sealed wine, the containers were vacuum flushed before being sealed. Table 11 indicates the performance characteristics of Examples 13-18 in preventing odor from the various liquids from reaching the exterior of the containers.

TABLE 9
Multi-Layered Barrier Structures in Examples 13-18

| Example 13 | | Example 14 | | Example 15 | | Example 16 | | Example 17 | | Example 18 | |
|---|---|---|---|---|---|---|---|---|---|---|---|
| Layer | | Layer | | Layer | | Layer | | Layer | | Layer | |
| (%) | Component | (%) | Component | (%) | Component | (%) | Component | (%) | Component | (%) | Component |
| 45.8 | EVA | 28.0 | EVA | 12.5 | EVOH + Surlyn | 34.0 | BOPET | 1.7 | HAVOH | 10.0 | HPP + EVA |
| 8.4 | PVdC | 11.0 | COC | 9.9 | Tie | 1.1 | HAVOH | 25.7 | PSA | 80.0 | EVA |
| 45.8 | EVA | 8.0 | tie | 61.2 | LDE | 17.0 | PSA | 72.6 | LLDPE | 10.0 | HPP + EVA |
| | | 6.0 | EVOH | 16.4 | EVA | 47.9 | LLDPE | | | | |
| | | 8.0 | tie | | | | | | | | |
| | | 11.0 | COC | | | | | | | | |
| | | 28.0 | EVA | | | | | | | | |

| | | | | | |
|---|---|---|---|---|---|
| Caliper = 60 μm | Caliper = 76 μm | Caliper = 67 μm | Caliper = 106 μm | Caliper = 70 μm | Caliper = 81 μm |

TABLE 10
Performance Characteristics in Examples 13-18 Containing Various Liquids

| | Results Through 330 Hours | | | | | | Results Through 2640 Hours | | | | | |
|---|---|---|---|---|---|---|---|---|---|---|---|---|
| | Water | Wine | Vac. | Average | Average | Average | Water | Wine | Vac. | Average | Average | Average |
| Example | Wt. | Wt. | Wine Wt. | Wt. | DG change | HSG change | Wt. | Wt. | Wine Wt. | Wt. | DG change | HSG change |
| No. | Loss | Loss | Loss (%) | Loss | Δ % | Δ % | Loss | Loss | Loss | Loss | Δ % | Δ % |
| 13 | −0.16% | −0.15% | −0.33% | −0.21% | −57.0% | −56.3% | −1.61% | −1.04% | −1.94% | −1.53% | −42.90% | −41.03% |
| 14 | −0.63% | −0.79% | −0.76% | −0.73% | −0.5% | −0.70% | −5.96% | −5.11% | −6.49% | −5.85% | 5.70% | 8.40% |
| 15 | −0.29% | −0.31% | −0.41% | −0.34% | 23.8% | 30.13% | −3.06% | −2.32% | −2.91% | −2.76% | 6.37% | 14.90% |
| 16 | −0.20% | −0.16% | Sample | −0.18% | −50.9% | −53.45 | −2.19% | −1.40% | Sample | −1.79% | 8.35% | 24.10% |
| | | | failure | | | | | | failure | | | |
| 17 | −0.35% | −0.54% | −0.78% | −0.56% | 5.3% | 11.23% | −3.20% | −1.89% | −4.74% | −3.28% | 14.27% | 42.23% |
| 18 | −0.81% | −0.92% | −1.04% | −0.92% | −9.0% | −5.93% | −9.07% | −4.57% | −7.67% | −7.10% | −5.83% | 0.83% |

TABLE 11
Performance Characteristics in Examples 13-18 Containing Various
Liquids

| | Odor of Wine | Odor of Vacuumed Wine |
|---|---|---|
| Example | 5 = Strong odor | 5 = Strong odor |
| No. | 1 = No odor | 1 = No odor |
| 13 | 2.33 | 4.00 |
| 14 | 4.33 | 3.00 |
| 15 | 4.00 | 2.00 |
| 16 | 1.50 | Sample failure |
| 17 | 3.00 | 5.00 |
| 18 | 4.33 | 3.00 |

In Table 9, the various components abbreviations have the following meanings:

BOPET Biaxially Oriented Polyester Terephthalate

BVOH Butenediol Vinyl Alcohol

COC Cyclic Olefin Copolymer (Norbornene)

EVA Ethylene Vinyl Acetate

EVOH Ethylene Vinyl Alcohol

HAVOH Highly Amorphous Vinyl Alcohol (a.k.a. G-Polymer, BVOH)

HPP Polypropylene Homopolymer

LDE Low-Density Elastomer

LLDPE Linear Low Density Polyethylene

PSA Pressure-Sensitive Adhesive

PVdC Polyvinylidene Chloride

tie Maleic Anhydride grafted polymer.

As can be seen, the container formed from the multi-layer construction of Example 16 was able to reduce the amount of DG and HSG up to at least 330 hours with only a minimal amount of average liquid loss from the interior of the container for water, wine, and vacuumed wine. Further, the container of Example 16 gave off the least amount of odor for wine compared to the other examples. Such performance characteristics through 330 hours were comparable to, or exceeded, those of the comparative Examples 13-15 and 18.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter addresses many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scopes of the claimed subject matter, as expressed in the appended claims.

What is claimed is:

1. A multi-layer barrier construction defining a first side and an oppositely directed second side, the multi-layer barrier construction comprising:
a first moisture-impermeable layer;
an adhesive layer disposed on a side of the first moisture-impermeable layer closest to the second side of the multi-layer barrier construction;
a highly amorphous vinyl alcohol polymer layer disposed on a side of the adhesive layer closest to the second side of the multi-layer barrier construction and directly abutting the adhesive layer; and
a second moisture-impermeable layer disposed on a side of the highly amorphous vinyl alcohol polymer layer closest to the second side of the multi-layer barrier construction,
wherein the multi-layer barrier construction is configured to reduce an amount of gas on the first side of the barrier construction.

2. The multi-layer barrier construction of claim 1, wherein the highly amorphous vinyl alcohol polymer layer is directly abutting the second moisture-impermeable layer and wherein the first moisture-impermeable layer is directly abutting the adhesive layer.

3. The multi-layer barrier construction of claim 1, wherein the highly amorphous vinyl alcohol polymer layer comprises a resin composition including (A) a polyvinyl alcohol (PVA) resin having a 1,2-diol structure of formula (1): 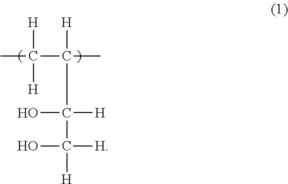
and an alkylene oxide adduct of a polyvalent alcohol containing 5 to 9 moles of an alkylene oxide per 1 mole of the polyvalent alcohol.

4. The multi-layer barrier construction of claim 3, wherein the PVA resin has a saponification degree of 80 mol. % to 97.9 mol. %.

5. The multi-layer barrier construction of claim 1, wherein the highly amorphous vinyl alcohol has an average level of crystallinity of less than about 35%.

6. The multi-layer barrier construction of claim 1, wherein the highly amorphous vinyl alcohol polymer layer has a coating weight of from about 0.1 g/m² to about 85 g/m².

7. The multi-layer barrier construction of claim 6, wherein the highly amorphous vinyl alcohol polymer layer has a coating weight of about 1.2 g/m².

8. The multi-layer barrier construction of claim 1, wherein the adhesive layer comprises an adhesive selected from one of solvent adhesive, water-based adhesive, hot-melt adhesive, olefin-block copolymer adhesive, and combinations thereof.

9. The multi-layer barrier construction of claim 8, wherein the adhesive comprises a water-based pressure sensitive adhesive.

10. The multi-layer barrier construction of claim 9, wherein the water-based pressure sensitive adhesive has a viscosity in the range of from about 800 to about 3000 centipoise.

11. The multi-layer barrier construction of claim 1, wherein the adhesive layer is present at a coating weight of from about 4 g/m² to about 30 g/m².

12. The multi-layer barrier construction of claim 11, wherein the adhesive layer is present at a coating weight of from about 18 g/m².

13. A container comprising:
a multi-layer barrier construction configured to reduce an amount of gas in an interior region of the container, the multi-layer barrier construction including;
a barrier layer including a highly amorphous vinyl alcohol polymer, the barrier layer defining an inner face that faces the interior region of the container and an oppositely directed outer face; and
an adhesive layer disposed directly on the inner face of the barrier layer.

14. The container of claim 13, wherein the multi-layer barrier construction further comprises:
a moisture-impermeable interior layer disposed on a side of the adhesive layer closest to the interior region of the container; and
a moisture-impermeable exterior layer disposed on a side of the barrier layer furthest from the interior region of the container.

15. The container of claim 14, wherein the interior layer is disposed directly on the adhesive layer.

16. The container of claim 14, wherein the exterior layer is disposed directly on the outer face of the barrier layer.

17. The container of claim 13, wherein the multi-layer barrier construction is sealed to itself to thereby define the interior region of the container.

18. The container of claim 13, the container further comprising a tray, wherein the multi-layer barrier construction is sealed to the tray to thereby define the interior region of the container.

19. The container of claim 13, wherein the highly amorphous vinyl alcohol polymer comprises a resin composition including (A) a polyvinyl alcohol (PVA) resin having a 1,2-diol structure of formula (1): 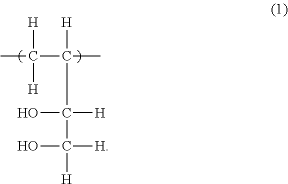
and an alkylene oxide adduct of a polyvalent alcohol containing 5 to 9 moles of an alkylene oxide per 1 mole of the polyvalent alcohol.

20. The container of claim 19, wherein the PVA resin has a saponification degree of 80 mol. % to 97.9 mol. %.

21. The container of claim 13, wherein the barrier layer is present at a coating weight of from about 0.1 g/m² to about 85 g/m².

22. The container of claim 21, wherein the barrier layer is present at a coating weight of from about 1 g/m² to about 2 g/m².

23. The container of claim 13, wherein the adhesive layer comprises an adhesive selected from one of solvent adhesive, water-based adhesive, hot-melt adhesive, olefin-block copolymer adhesive, and combinations thereof.

24. The container of claim 23, wherein the adhesive comprises a water-based pressure sensitive adhesive.

25. The container of claim 13, wherein the adhesive layer is present at a coating weight of from about 4 g/m² to about 30 g/m².

26. The container of claim 25, wherein the adhesive layer is present at a coating weight of from about 15 g/m² to about 20 g/m².

27. The container of claim 13, wherein the interior layer comprises mLLDPE, ULDPE, and LLDPE, and wherein an average thickness of the interior layer ranges from about 20 microns (μm) to about 100 μm.

28. The container of claim 13, wherein the exterior layer comprises PET, and wherein an average thickness of the exterior layer ranges from about 20 μm to about 100 μm.

29. The container of claim 13, wherein the adhesive layer is a first adhesive layer, the multi-layer barrier construction further comprising a second adhesive layer disposed on the outer face of the barrier layer between the barrier layer and the exterior layer.

30. A combination comprising:
a container and a material sealed in an interior of the container, the container including a multi-layer construction defining a first side facing the interior of the container and an oppositely directed second side, the multi-layer construction including;
a moisture-impermeable interior layer;
an adhesive layer disposed on a side of the interior layer furthest from the first side of the multi-layer construction;
a highly amorphous vinyl alcohol polymer layer disposed on a side of the adhesive layer furthest from the first side of the multi-layer construction, the highly amorphous vinyl alcohol polymer layer directly abutting the adhesive layer;
a moisture-impermeable exterior layer disposed on a side of the highly amorphous vinyl alcohol polymer layer furthest from the first side of the multi-layer construction,
wherein the multi-layer construction is configured to reduce an amount of the one or more components of air that is present in the interior of the container.

31. The combination of claim 30, wherein the material is susceptible to degradation upon exposure to one or more components of air.

32. The combination of claim 30, wherein the interior layer defines the first side of the multi-layer construction.

33. The combination of claim 30, wherein the exterior layer defines the second side of the multi-layer construction.

34. The combination of claim 30, wherein the adhesive layer is directly abutting the interior layer.

35. The combination of claim 30, wherein the exterior layer is directly abutting the highly amorphous vinyl alcohol polymer layer.

36. The combination of claim 30, wherein the multi-layer construction is sealed to itself to thereby define the container.

37. The combination of claim 30, wherein the highly amorphous vinyl alcohol polymer comprises a resin composition including (A) a polyvinyl alcohol (PVA) resin having a 1,2-diol structure of formula (1): 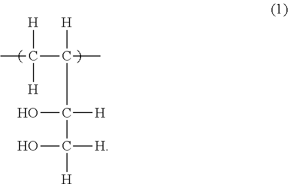
and an alkylene oxide adduct of a polyvalent alcohol containing 5 to 9 moles of an alkylene oxide per 1 mole of the polyvalent alcohol.

38. The combination of claim 37, wherein the PVA resin has a saponification degree of 80 mol. % to 97.9 mol. %.

39. The combination of claim 30, wherein the barrier layer is present at a coating weight of from about 0.1 g/m² to about 85 g/m².

40. The combination of claim 30, wherein the adhesive layer comprises an adhesive selected from one of solvent adhesive, water-based adhesive, hot-melt adhesive, olefin-block copolymer adhesive, and combinations thereof.

41. The combination of claim 40, wherein the adhesive comprises a water-based pressure sensitive adhesive.

42. The combination of claim 30, wherein the adhesive layer is present at a coating weight of from about 4 g/m² to about 30 g/m².

43. The combination of claim 30, further comprising packaging disposed at an exterior of the container.

44. A method of making a multi-layer construction defining a first side and an oppositely directed second side, the multi-layer construction configured to reduce an amount of gas on the first side of the construction, the method comprising:
providing a moisture-impermeable first layer having a first face and an oppositely directed second face, the first face defining the first side of the construction;
disposing an adhesive second layer on a side of the moisture-impermeable first layer that is nearest the second side of the multi-layer construction; and
depositing a highly amorphous vinyl alcohol polymer third layer on a side of the adhesive second layer that is opposite from the moisture-impermeable first layer, such that the adhesive second layer and the highly amorphous vinyl alcohol polymer third layer directly abut.

45. The method of claim 44, further comprising arranging a moisture-impermeable fourth layer on a side of the highly amorphous vinyl alcohol polymer third layer opposite from the adhesive second layer.

46. The method of claim 45, wherein the moisture-impermeable fourth layer and highly amorphous vinyl alcohol polymer third layer directly abut.

47. The method of claim 44, wherein the moisture-impermeable first layer and the adhesive second layer directly abut.

48. The method of claim 44, wherein the highly amorphous vinyl alcohol polymer third layer comprises a resin composition including (A) a polyvinyl alcohol (PVA) resin having a 1,2-diol structure of formula (1): 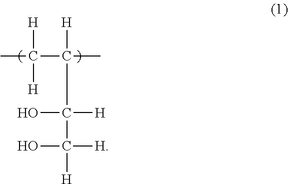
and an alkylene oxide adduct of a polyvalent alcohol containing 5 to 9 moles of an alkylene oxide per 1 mole of the polyvalent alcohol.

49. The method of claim 48, wherein the PVA resin has a saponification degree of 80 mol. % to 97.9 mol. %.

50. The method of claim 44, wherein the highly amorphous vinyl alcohol polymer third layer is formed by adding together a highly amorphous vinyl alcohol polymer and water to form a barrier composition, and drying the barrier composition to thereby form the highly amorphous vinyl alcohol polymer third layer

51. The method of claim 50, wherein the barrier composition is applied at a wet coating weight such that upon drying of the barrier composition to remove the water, the highly amorphous vinyl alcohol polymer layer is formed having a dry coating weight of from about 0.1 g/m² to about 85 g/m².

52. The method of claim 44, wherein the adhesive layer comprises an adhesive selected from one of solvent adhesive, water-based adhesive, hot-melt adhesive, olefin-block copolymer adhesive, and combinations thereof.

53. The method of claim 52, wherein the adhesive comprises a water-based pressure sensitive adhesive.

54. The method of claim 44, wherein the adhesive layer is present at a coating weight of from about 4 g/m² to about 30 g/m².

55. The method of claim 54, wherein the adhesive layer is present at a coating weight of from about 18 g/m².

56. A method of reducing an amount of gas in a container, the container including a wall that separates an interior of the container from an exterior of the container, the method comprising:
providing a multi-layer construction including a highly amorphous vinyl alcohol polymer layer and an adhesive layer, the adhesive directly abutting the highly amorphous vinyl alcohol polymer layer; and
arranging the multi-layer construction such that the construction defines at least a portion of the wall separating the interior from the exterior and the adhesive layer is disposed on a side of the highly amorphous vinyl alcohol polymer layer closest to the interior of the container;
wherein the highly amorphous vinyl alcohol polymer layer is subject to conditions less than about 65% relative humidity.

57. The method of claim 56, wherein the construction further includes a water impermeable interior layer in direct communication with the interior of the container and configured to prevent the highly amorphous vinyl alcohol polymer layer from being exposed to conditions above about 65% relative humidity.

58. The method of claim 56, wherein the construction further includes a water impermeable exterior layer in direct communication with the exterior of the container and configured to prevent the highly amorphous vinyl alcohol polymer layer from being exposed to conditions above about 65% relative humidity.

59. The method of claim 56, wherein the highly amorphous vinyl alcohol polymer layer comprises a resin composition including (A) a polyvinyl alcohol (PVA) resin having a 1,2-diol structure of formula (1): 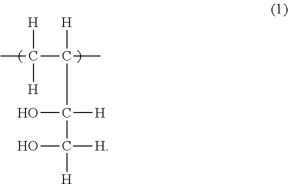
and an alkylene oxide adduct of a polyvalent alcohol containing 5 to 9 moles of an alkylene oxide per 1 mole of the polyvalent alcohol.

60. The method of claim 59, wherein the PVA resin has a saponification degree of 80 mol. % to 97.9 mol. %.

61. The method of claim 56, wherein the highly amorphous vinyl alcohol polymer layer has a coating weight of from about 0.1 g/m² to about 85 g/m².

62. The method of claim 61, wherein the highly amorphous vinyl alcohol polymer layer has a coating weight of about 1.2 g/m².

63. The method of claim 56, wherein the adhesive layer comprises an adhesive selected from one of solvent adhesive, water-based adhesive, hot-melt adhesive, olefin-block copolymer adhesive, and combinations thereof.

64. The method of claim 63, wherein the adhesive comprises a water-based pressure sensitive adhesive.

65. The method of claim 56, wherein the adhesive layer is present at a coating weight of from about 4 g/m² to about 30 g/m².

66. The method of claim 65, wherein the adhesive layer is present at a coating weight of from about 18 g/m².

67. The method of claim 56, wherein the construction defines the entire wall.

68. The method of claim 67, wherein the construction is sealed to itself to define the container.
